(19) United States
(12) Patent Application Publication
(10) Pub. No.: US 2005/0139470 A1
(43) Pub. Date: Jun. 30, 2005

(54) Device for isoelectric focussing

(76) Inventor: Siu Kwan Sze, Singapore (SG)

Correspondence Address: Baker Botts, 30 Rockefeller Plaza, New York, NY, 10112, US

(21) Appl. No.: 10/503,507

(22) PCT Filed: Dec. 30, 2002
(86) PCT No.: PCT/SG02/00298

Related U.S. Application Data
(60) Provisional application No. 60/357,369, filed on Feb. 19, 2002.

(51) Int. Cl. G01N 27/453

(52) U.S. Cl. 204/548; 204/644

(57) ABSTRACT

A device for separating one or more components in a sample is disclosed, the device including: (a) a first planar member (1) having a channel (2) along which a sample may be loaded and component(s) thereof focussed isoelectrically; and (b) means for exposing the channel (2) along at least a portion of its length and thereby exposing the sample or component(s) therewithin. The means for exposing the channel (2) may include a cover plate (7). A method of analysing a molecule is also provided, the method including: (a) providing an elongate open channel (2); (b) introducing a plurality of molecules into the elongate open channel (2); (c) separating molecules along the elongate open channel (2) according to their isoelectric points; (d) accessing a molecule in the elongate open channel (2) and analysing it. A use of the device in combination with a mass spectrometer, preferably a MALDI-TOF unit, for analysis of a protein is also disclosed.

### FIELD

The present invention relates to a device and method for separating molecules, in particular macromolecules such as proteins. In particular, the invention relates to a device capable of charge-based separation of proteins.

### BACKGROUND

The separation of molecules in a complex mixture is often desired for various purposes. For example, a multitude of proteins exist within a cellular environment, and in order to aid characterisation, it is often necessary to separate these proteins from each other. Various separation techniques have been developed, each of which rely on one or more differing properties of the proteins to separate them from each other.

For example, sodium dodecyl sulphate-polyacrylamide gel electrophoresis (SDS-PAGE) separates proteins according to their size. In SDS-PAGE, proteins are denatured and solubilised in a SDS buffer, negatively charged SDS molecules bind to the protein, with more molecules binding to larger proteins. On application of an electric field, proteins migrate in a polyactylamide gel according to their charge (and hence size). The electric field is turned off to immobilise the proteins within the gel. We can refer to techniques such as SDS-PAGE as “single dimension” separation, as separation is based on only one property of the protein (in this case mass).

The analysis of complex mixtures, however, often requires more than one separation process in order to resolve all the components present in a sample. It is for this reason that two dimensional (2D) separation schemes have been devised.

Two dimensional separation techniques make use of two properties of the proteins for separation. Separation is carried out in one dimension by use of a first property, and then a second dimension (which is generally orthogonal or perpendicular to the first dimension) by means of a second property. When constructing a successful 2D system several criteria need to be addressed. For example, the two techniques should base their respective separations on as different a means as possible. Doing so will reduce the amount of redundant information contained in the 2D dataset. 2D techniques are advantageous as they provide higher resolution. For example, they may be able to resolve several different proteins which differ only marginally in mass, but have different charges (such as in the case of differentially phosphorylated proteins).

Two dimensional polyacrylamide gel electrophoresis (2-D PAGE) is a popular and currently favoured technique for protein separation (Anderson N. G., Anderson N. L., Electrophoresis 1996; 17, 443453). Proteins are first subjected to isoelectric focusing (IEF) in an immobilized pH gradient in the slab gel format to separate proteins according to their charge (pI values), a step which typically takes about 6-8 hours. Then, the IEF gel is placed on top of a gradient gel and electrophoresed in the presence of SDS to separate proteins based on their molecular mass. The separated proteins are stained for visualization, interested bands are excised and digested with protease followed by peptide finger printing by mass spectrometry for protein identification (Shevchenko, A., Jensen, 0. N., Podtelejnikov, A. V., Sagliocco, F., Wilm, M., Vorm, O., Mortensen, P., Boucherie, H., Mann, M., Proc. Natl. Acad. Sci. U.S.A. 1996, 93, 14440-14445; Jensen, O. N., Larsen, M. R., Roepstorff, P., PROTEINS 1998, 74-89 Suppl. 2).

2-D PAGE is the current technology of choice for large scale proteomics analysis because 2-D PAGE is the highest resolution method for protein separation and the pattern of proteins in the 2-D map is related to the properties of proteins, namely isoelectric point in first dimension and molecular mass in the second dimension. Therefore, the positions of proteins in 2-D map correspond to their chemical and physical properties. These properties can be used to identify and characterize the proteins. 2-D PAGE has been used to analyze human plasma proteins, and the pI and molecular weight of proteins can be used for detection and diagnosis of diseases in clinical analysis (Rasmussen, R K., Ji, H., Eddes, J. S., Moritz, R L., Reid, G. E., Simpson, R. J., Dorow, D. S., Electrophoresis 1997, 18, 588-598).

However, 2-D PAGE is a labour intensive procedure and difficult to automate, it also suffers from its limitations in sensitivity and dynamic range of detection. Virtual 2-D gel electrophoresis has recently been developed (Ogorzalek-Loo, R. R., Cavalcoli, J. D., VanBogelen, R A., Mitchell, C., Loo, J. A., Moldover, B., Andrews, P. C., Anal. Chem. 2001, 73, 40634070), where mass spectrometry replaces the size-based separation of SDS-PAGE in the second dimension. It has been shown that this technology is more sensitive than 2-D PAGE. However, the first dimension of separation is still performed in polyacrylamide gel, limiting the potential for high throughput analysis.

Mass spectrometry (MS) is an important analytical technique for molecular structure characterization because of its high specificity, sensitivity and speed (McLafferty, F. W., Science 1981, 214, 280287). Techniques such as electrospray ionization (ESI), described in Fenn, J. B., Mann, M., Meng, C. K., Wong, S. F., Whitehouse, C. M., Science 1989, 246, 64-71, and matrix-assisted laser desorption/ionization (MALDI), described in Karas, M., Hillenkamp, F., Anal. Chem 1988, 60, 2299-2301, have greatly extended the capacity of mass spectrometry to study non-volatile and labile biomolecules. A variety of micro-separation techniques have been exploited to interface to mass spectrometry for molecular identification. The interface of microcolumn separation to electrospray ionization mass spectrometry is the most common system (Tomer, K. B., Chem. Rev. 2001, 101, 297-328), and is described for example in U.S. Pat. No. 5,993,633. Other techniques involve for example depositing effluent from capillary electrophoretic separation on a MALDI target plate (Minarik M., Foret F., Karger B. L., Electrophoresis 2000, 21, 247-254).

In capillary zone electrophoresis (CZE) a sample is dissolved in a buffer and the sample is injected at one end of a separation capillary or channel. Ie separation capillary or channel may also be loaded with a uniform buffer solution, and a sample injected at one end. A constant voltage potential is applied along the separation channel so that ions move at rates corresponding to their electrophoretic mobilities. Since different ionic species have different charge-to-mass ratios, they separate as they migrate along the channel. Liu et al (2001, Anal. Chem. 73, 2147-2151) describe a 2-dimensional separation system, which couples capillary zone electrophoresis (CE or CZE) with MALDI. Separation is first performed in open microchannels manufactured on glass microchips. Samples are introduced at one end of the channel, and separated. The microchips are then transferred to a MALDI source after evaporation of solvent. Separation in the first dimension occurs by a combination of electrophoresis and electroosmosis, and electroosmotic movement of peptides and oligosaccharides is demonstrated.

Electroosmosis, or electroendosmosis, is a bulk flow phenomenon which affects separation during capillary electrophoresis, particularly in glass channels. The velocity of an analyte in capillary electrophoresis depends not only on the forces applied by the electrical potential, but also upon the rate of endoosmotic flow (EOF) within the channel. Endoosmotic flow is observed when an electric field is applied to a solution contained in a capillary with fixed charges on the capillary wall, for example, a glass capillary wall. Typically, charged sites are created by ionization of silanol groups on the inner surface of the fused silica. Silanols are weakly acidic, and ionize at pH vales above about pH 3. Hydrated cations in solution associate with ionized SiO⁻ groups to from an electrical double layer, a static inner layer close to the surface (also known as the Stern Layer) and a mobile outer layer (also termed the Helmholtz plane). Upon application of an electric field, hydrated cations in the outer layer move towards the cathode, creating a new flow of the bulk liquid in the capillary in the same direction. The rate of movement is dependent on the field strength and the charge density of the capillary wall. The population of charged silanols is a function of the pH of the medium, so that the magnitude of the EOF increases directly with pH until all available silanols are fully oxidised. Electroosmosis is described in further detail in Wehr, T., Rodriguez-Diaz, R, Zhu, M., Capillary Electrophoresis of Proteins, Marcel Dekker, Inc., New York, 1999.

Capillary isoelectric focussing (CIEF) is an equilibrium-based method of separation that depends on a pH gradient created by carrier ampholyte. Proteins move under an electric field to their pI points where they carry zero charge and are focused. Therefore, separation and concentration occur at the same time. The concentration of proteins at the focused zone can be increased by 100-500 times relative to the starting solution because the same protein in the whole capillary is focused on a single spot.

Single point detection techniques, such as laser induced fluorescence and ESI-MS, have been employed to detect the separated proteins after CIEF. Focused protein zones need to be mobilized in order to pass through the detection point at the end of the tube (Rodriguez, R., Zhu, M., Wehr, T., J Chromatogr. A 1997, 772, 145-160).

MAILDI, such as MALDI-MS and MALDI-TOF are important techniques for measuring large molecular masses accurately and studying protein-ligand interactions, but successful interfacing with chromatography, in particular, capillary electrophoresis, has yet to be successfully achieved. The problem of interfacing CIEF MALDI-MS is because the focused protein zone inside the capillary cannot be reached directly. Therefore, the contents of the capillary need to be mobilized out of the capillary and deposited into an appropriate surface for subsequence MALDI ionization. This mobilization step degrades the resolution, increases the analysis time, and distorts the pH gradient. Hence, the result reproducibility is poor.

### SUMMARY

According to a first aspect of the present invention, we provide an isoelectric focussing (IEF) module comprising: (a) a first planar member having a channel along which a sample may be loaded and a component or components thereof focussed isoelectrically; and (b) means for exposing the channel along at least a portion of its length and thereby exposing the sample or component(s) therewithin.

Preferably, the sample or component(s) are accessible along the exposed channel at substantially the positions at which they are focussed. Preferably, the channel comprises an open channel which is exposed along at least a portion of its length. Preferably, the channel comprises a linear groove formed on a surface of the first planar member.

In preferred embodiments, the channel comprises a microchannel or capillary channel. Preferably, the microchannel or capillary channel is microfabricated on the first planar member.

The channel may have a width of between 1 to 500 micrometres, more preferably between 50 to 350 micrometres, more preferably between 50 to 350 micrometres, most preferably about 150 micrometers or about 175 micrometres.

The first planar member may be formed from a material selected from the group consisting of: plastics, polymers, ceramic, glass or composite. Preferably, at least one wall of the channel comprises poly(methylmethacrylate) (PMMA) or polycarbonate. Preferably, the first planar is coated or derivatised to reduce surface charge and thereby minimise electroosmotic flow (EOF).

The module may comprise reservoirs for electrolyte, the reservoirs being in electrical connection with the channel. Preferably, the reservoirs are formed on the first planar member adjacent to each end of the channel.

In some embodiments, the module further comprises a lid being a second planar member, which reduces evaporation of the sample in the channel. Preferably, the lid comprises an elongate recess on its inner face, the recess being positioned such that when the lid is mated with the first planar member, no substantial leakage of sample contained in the channel occurs.

Preferably, the length and width of the recess are at least as great as a channel in the first planar member. In such embodiments, the reservoirs are preferably disposed on the lid.

Preferably, the module comprises means for electrical connection between the channel and the reservoir, but preventing substantial mixing of sample and electrolyte. The means may comprise a semi-permeable membrane, agarose, acrylamide, agar, or a gel plug.

In highly preferred embodiments, the module comprises a plurality of channels in substantially parallel orientation.

In certain embodiments, the channel or channels comprises a closed channel(s) and the means for exposing the channel(s) comprises lines of weakness enabling fracture along a longitudinal plane of the channel(s).

Preferably, the module comprises a translational stage on which is mounted the first planar member.

There is provided, according to a second aspect of the present invention, an apparatus for separating one or more components in a sample, the apparatus comprising an isoelectric focussing (IEF) module as set out in the first aspect of the invention, together with a module capable of separating isoelectrically focussed components according to their respective masses.

Preferably, the mass separation module comprises a module for mass spectrometry. Preferably, the mass separation module comprises a matrix assisted laser desorption/ionisation mass spectrometry (MALDI-MS) module, preferably, a matrix assisted laser desorption/ionisation-time of flight (MALDI-TOF) module.

We provide, according to a third aspect of the present invention, a method of separating one or more components in a sample, the method comprising the steps of: (a) providing an isoelectric focussing (IEF) module comprising a first planar member having a channel; (b) loading the channel with a sample; (c) isoelectrically focussing a component or components of the sample along the channel; and (d) exposing the channel along at least a portion of its length and thereby exposing the sample or component(s) therewithin.

The method may comprise one or more features as defined in the preferred embodiments of the first aspect of the invention.

The method may further comprise the step of: (e) accessing one or more components in the open channel and analysing it. Preferably, the or each component is analysed by mass spectrometry, preferably by MALDI-MS, more preferably by MALDI-TOF mass spectrometry.

Preferably, the sample comprises a MALDI matrix. Preferably, a MALDI matrix is added to the sample subsequent to isoelectric focussing. Preferably, the MALDI matrix is selected from the group consisting of: Cyano-4-hydroxycinnamic acid (CHCA), 2,5-Dihydroxy benzoic acid (DHB), Alpha CCA, Sinapinic Acid (SA), 3-hydroxypicolinic acid (HPA), IAA (Na⁺), 2-(4-Hydroxyphenylazo)benzoic acid HABA (Na⁺), Dithranol (Na⁺), Retinoic Acid (Na⁺), Succinic acid, 2,6-Dihydroxyacetophenone, Ferulic Acid, Caffeic acid, Glycerol and 4-Nitroaniline.

As a fourth aspect of the present invention, there is provided a method of analysing a molecule, the method comprising: (a) providing an elongate open channel; (b) introducing a plurality of molecules into the elongate open channel; (c) separating molecules along the elongate open channel according to their isoelectric points; (d) accessing a molecule in the elongate open channel and analysing it.

We provide, according to a fifth aspect of the present invention, an apparatus for isoelectric focussing (IEF) of molecules, the apparatus comprising an elongate channel, in which the elongate channel is open along at least a portion of its length to enable separated molecules to be accessed.

The present invention, in a sixth aspect, provides a CIEF-MALDI apparatus.

In a seventh aspect of the present invention, there is provided a kit comprising a module or apparatus as described above, together with a sample comprising proteins to be analysed.

According to an eighth aspect of the present invention, we provide use of an isoelectric focussing module as described above, in combination with a mass spectrometer, preferably a MALDI-MS unit, more preferably a MALDI-TOF unit, for analysis of a protein. Preferably, such use is for proteome analysis.

We provide, according to a ninth aspect of the invention, a means for interfacing a capillary isoelectric focussing (CIEF) apparatus and a MALDI-MS apparatus (preferably a MALDI-TOF apparatus), the interface means comprising a channel along which isoelectric focussing is carried out, and means for exposing said channel along at least a portion of its length and thereby exposing the sample or component(s) therewithin.

Preferably, the interface comprises an open channel.

### BRIEF DESCRIPTION OF THE DRAWINGS

FIG. 1 is a diagram showing a plan view of a first embodiment of a separation device as described here, comprising a single open channel with reservoirs “in cis” (i.e., on the same substrate as the open channels). 1: substrate, 2: open channel, 3 and 4: anolyte and catholyte reservoirs (electrolyte reservoirs), 31: agarose gel plug.

FIG. 1B is a diagram showing a longitudinal cross section of the embodiment of the separation device shown in FIG. 1A.

FIGS. 2A to 2D are diagrams showing transverse cross sections of embodiments of the separation device comprising a single open channel, illustrating various configurations of the open channel. FIG. 2A shows a channel with straight walls and base. FIG. 2B shows a “U” shaped channel with straight walls and a curved base. FIG. 2C shows a “U” shaped channel with curved walls and a straight base. FIG. 2D shows a “U” shaped channel with curved walls and a curved base.

FIG. 3 is a diagram showing a longitudinal cross section of the embodiment of the separation device shown in FIG. 1A, mounted on a stage. The stage may comprise for example an XY-translation stage for MALDI. 5: stage, 6: laser beam.

FIGS. 4A to 4C are diagrams showing a second embodiment of a separation device as described here, comprising multiple open channels with integral reservoirs. FIG. 4A shows a plan view and FIG. 4B shows a transverse cross section of the separation device. FIG. 4C shows a longitudinal cross section of the separation device mounted on a stage, for example an XY-translation stage for MALDI. 1, 2, 3, 31, 4, 5, 6 are as described in legend to FIG. 1A and FIG. 3.

FIGS. 5A to 5C are diagrams showing a third embodiment of a separation device as described here, comprising a single open channel and reservoirs “in trans” (i.e., not on the same substrate as the open channels). FIG. 5A: plan view of separation device with lid detached. FIG. 5B: plan view of device with lid in place. 7: lid, 8: recess in lid, shown in outline (dashed lines).

FIGS. 6A and 6B are diagrams showing a transverse section of the third embodiment of FIG. 5 along a plane of the reservoir. FIG. 6A: open configuration; with lid removed. FIG. 6B: closed configuration, with lid in place.

FIGS. 7A to 7C are diagrams showing a fourth embodiment of a separation device as described here, comprising multiple open channels and reservoirs “in trans”, in which the reservoirs are on a separate piece from the open channels. FIG. 7A: plan view of separation device without lid. FIG. 7B: plan view of separation device covered with lid. Recesses (8) in lid are shown in outline.

FIGS. 8A and 8B are diagrams showing a transverse section of the fourth embodiment of FIG. 7 along a plane of the reservoirs. FIG. 8A: open configuration, with lid removed. FIG. 8B: closed configuration, with lid in place.

FIG. 9 is a composite photograph showing isoelectric focussing of myoglobin. Top lane: t=0, bottom lane: t=end of experiment. Arrow shows direction of time.

FIG. 10 is a photograph showing the separation device mounted on an adaptor for attachment to a MALDI sample plate. 9: adaptor.

FIG. 11 is a graph showing MALDI TOF-MS of myoglobin from a focussed zone in the separation device. X-axis: mass to charge (m/z) ratio, Y-axis: intensity.

FIGS. 12A and 12B are photographs showing separation of whole porcine liver proteins. FIG. 12A: open channel with visible focussed protein (arrow), the adjacent ruler shows a scale and is intended to estimate the pI value. FIG. 12B: enlargement of FIG. 12A showing three visible protein spots at about 8 cm, indicated by arrows.

The practice of the present invention will employ, unless otherwise indicated, conventional techniques of chemistry, molecular biology, microbiology, recombinant DNA and immunology, which are within the capabilities of a person of ordinary skill in the art. Such techniques are explained in the literature. See, for example, J. Sambrook E. F. Fritsch, and T. Maniatis, 1989, Molecular Cloning: A Laboratory Manual, Second Edition, Books 1-3, Cold Spring Harbor Laboratory Press; Ausubel, F. M. et al. (1995 and periodic supplements; Current Protocols in Molecular Biology, ch. 9, 13, and 16, John Wiley & Sons, New York, N.Y.); B. Roe, J. Crabtree, and A. Kahn, 1996, DNA Isolation and Sequencing Essential Techniques, John Wiley & Sons; J. M. Polak and James O'D. McGee, 1990, In Situ Hybridization: Principles and Practice; Oxford University Press; M. J. Gait (Editor), 1984, Oligonucleotide Synthesis: A Practical Approach, Irl Press; and, D. M. J. Lilley and J. E. Dahlberg, 1992, Methods of Enzymology: DNA Structure Part A: Synthesis and Physical Analysis of DNA Methods in Enzymology, Academic Press. An extensive review of 2-D PAGE techniques, and their application in proteome analysis, is provided by Andrew J. Link, 2-D Proteome Analysis Protocols, Vol. 112, Humana Press ISBN: 0896035247. Each of these general texts is herein incorporated by reference.

### DETAILED DESCRIPTION

We disclose a module/apparatus which separates proteins using isoelectric focussing, and which is adapted for easy interfacing with mass spectrometry, in particular MALDI mass spectrometry (MALD-MS). In particular, the module is adapted for easy interface with MALDI-TOF. In particular, our module/apparatus employs 2D separation using charge in a first dimension (isoelectric focussing), and mass in the second (MALDI, preferably MALDI-TOF).

The apparatus/module and method described here enables rapid and accurate focussing of components of a sample, in particular, protein components of the sample, along a channel, and enabling access to these. This is achieved by providing means for exposing the channel along at least a portion of its length, preferably the whole or substantially the whole of its length. Specific embodiments of such a device and method are described in further detail below. Embodiments where the channel is “open” are preferred, and provide random access to any target protein along the microchannel. The target protein may be extracted, or may be analysed in situ. The target protein may be removed for analysis, for example, by interfacing the channel or microchannel to a mass spectrometry apparatus. Use of specific MS apparatus, such as MALDI or MALDI-TOF, is preferred.

The module, apparatus and method described here are therefore capable of detecting components in the sample, in particular, determining one or more properties of the or each component. In preferred embodiments, the module, apparatus and method described here is used for proteome analysis, i.e., analysing the protein components of a cell. The module, apparatus and method described here may also suitably be used for detection of one or more disease associated proteins in a sample from an individual. Such detection may be used as, or as a means to determine, a diagnosis of a disease.

Samples and Components

The method and apparatus described here is suitable for separating one or more components from a sample, which is typically a mixture of components. The sample may be a complex mixture, comprising hundreds or thousands of components. The components may be uniform in nature, but preferably are not In preferable aspects, two or more of the components may be distinguished by one or more properties, for example, charge, mass, etc.

Samples which are suitable for isoelectric focussing using our module or apparatus may therefore include different types. In particular, our methods and apparatus are suitable for separation and analysis of complex samples, for example, cell extracts. Cell and tissue extracts may be prepared by any means known in the art.

The samples may comprise simple molecules, complex molecules, or any mixture of these. They may comprise proteins, carbohydrates, nucleic acids, DNA, RNA, etc. Preferably, at least one of the components of the sample comprises an amphoteric molecule, such as a protein.

The sample may comprise one or more of the following: a protein, a peptide, a polypeptide, an amino acid, an oligonucleotide or modified oligonucleotide, an antisense oligonucleotide or modified antisense oligonucleotide, cDNA, genomic DNA, an artificial or natural chromosome (e.g. a yeast artificial chromosome) or a part thereof, RNA, including mRNA, tRNA, rRNA or a ribozyme, or a peptide nucleic acid (PNA); a virus or virus-like particles; a nucleotide or ribonucleotide or synthetic analogue thereof, which may be modified or unmodified; an amino acid or analogue thereof, which may be modified or unmodified; a non-peptide (e.g., steroid) hormone; a proteoglycan; a lipid; or a carbohydrate, etc.

Protein Containing Samples

Our method and device may be used to analyse any sample, in particular protein containing samples. In preferred embodiments, the methods and apparatus described here is suitable for separating samples comprising proteins. Preferably, the molecules which are isoelectrically focussed and/or analysed comprise proteins.

The proteins may preferably be human proteins, or animal proteins, mammalian proteins or bacterial or other microorganism proteins. The proteins may be native proteins, or denatured proteins. They may comprise wild type proteins, or mutated proteins, whether natural or man made. They may comprise post translational modifications, for example, any one or more of ADP-ribosylation, ubiquitination, glycosylation, prenylation (fatty acylation), sentrinization, phosphorylation, etc. The proteins may comprise one or more post-translationally modified groups such as methyl, phosphate, ubiquitin, glycosyl, fatty acyl, sentrin or ADP-ribosyl moiety. Such modifications are described for example in WO 00/50896, WO 00/50635, WO 00/50631, WO 00/50630 and GB2342652. The protein may be an isoform, and the sample may in particular comprise one or more protein isoforms.

The proteins may comprise recombinantly expressed proteins. Methods of producing recombinant proteins, methods of expression, vectors, and hosts suitable for expression are well known in the art.

Disease Associated Proteins

In preferred embodiments, the protein or proteins which is detected or analysed comprises a disease associated protein. By this term we mean a protein whose presence in a cell, tissue or organ of an individual is indicative of a disease state of the cell, tissue or organ. In preferred aspects, the protein is a flag or marker of a pathological condition. The protein may be a causative agent of the disease state, or it may not have any causative effect The protein may be a “downstream” indicator of disease. The disease associated protein may be indicative of the presence of the disease, or susceptibility to the disease, in an individual.

It will be appreciated that the disease associated protein itself need not be detected, and that any nucleic acid encoding it, for example, a disease associated-DNA, -mRNA, -gene, -allele, etc may be detected.

The disease may comprise any known disease, which affects humans or animals. The disease may in particular comprise infections such as bacterial, fungal, protozoan and viral infections, particularly infections caused by HIV-1 or HIV-2; pain; cancers; diabetes, obesity; anorexia; bulimia; asthma; Parkinson's disease; thrombosis; acute heart failure; hypotension; hypertension; erectile dysfunction; urinary retention; metabolic bone diseases such as osteoporisis and osteo petrosis; angina pectoris; myocardial infarction; ulcers; asthma; allergies; rheumatoid arthritis; inflammatory bowel disease; irritable bowel syndrome benign prostatic hypertrophy, and psychotic and neurological disorders, including anxiety, schizophrenia, manic depression, delirium, dementia, severe mental retardation and dyskinesias, such as Huntington's disease or Gilles dela Tourett's syndrome. Inflammatory diseases such as psoriasis, acne, eczema, etc are also included.

Preferred diseases include those which afflict or threaten first world populations, such as AIDS, cancer, Alzheimers disease, Parkinsons, CJD, etc.

The disease associated protein for a specific disease may be one which has previously been determined (i.e., a known disease associated protein), or it may be unknown. In the latter case, the methods, apparatus and module described here may suitably be utilised to determine the unknown disease associated protein.

A sample from a diseased individual is taken, and separated and analysed as described. One or more profiles may be generated; these may comprise for example, an isoelectric focussing profile (the disposition of the various proteins along the channel), or preferably a mass spectrometry profile. The mass spectrometry profile will include information on the molecular weights of the proteins present in the disease sample. The disease profile is then compared with a relevant profile generated from a normal (i.e, undiseased) individual.

Any differences in the profile indicate differences in the protein compositions of a normal versus a diseased individual. Such differences may provide markers for disease, and be used as putative disease associated proteins. They may be detected in other individuals as described to determine the presence of a disease, or susceptibility thereto.

Detection of such a disease associated protein in a cell, organ, etc, using the methods and apparatus described here may be used as an aid to diagnosis of the disease For certain diseases, such detection may be used as a direct diagnosis of the disease. Appropriate treatment may then be administered to the individual or patient in question.

Isoelectric Focussing

The module makes use of isoelectric focussing along a channel, preferably a narrow channel.

The term “isoelectric focussing” also known as IEF or electrofocusing, should be understood to refer to a technique in which solutes of different isoelectric points are caused to form stationary bands in an electric field, which is superimposed on a (stable) pH gradient, the pH increasing from the anode to the cathode. Preferably, the pH gradient is most conveniently formed by electrolysing a solution containing a mixture of carrier ampholytes of low molecular mass and slightly differing isoelectric points, each of which will move to its isoelectric region in the electric field and remain there.

In further detail, isoelectric focusing (IEF) is an electrophoretic technique that adds a pH gradient to the buffer solution and together with the electric field focuses most biological materials that are amphoteric. Amphoteric biomaterials such as proteins, peptides, nucleic acids, viruses, and some living cells are positively charged in acidic media and negatively charged in basic media. During IEF, these materials migrate in the pre-established pH gradient to their isoelectric point where they have no net charge and form stable, narrow zones. Isoelectric focusing yields such high resolution bands because any amphoteric biomaterial which moves away from its isoelectric point due to diffusion or fluid movement will be returned by the combined action of the pH gradient and electric field. The focusing process thus purifies and concentrates sample into bands that are relatively stable.

Isoelectric focussing is an electrophoretic process. “Electrophoretic” separations refers to the migration of particles or macromolecules having a net electric charge where said migration is influenced by an electric field. Accordingly electrophoretic separations contemplated for use in the apparatus and method described here include separations performed in channels packed with gels (such as polyacrylamide, agarose and combinations thereof) as well as separations performed in solution. Preferably, however, the separations take place in solution.

The term “isoelectric point” or pI, as used in this document, should be taken to mean the pH of the solution in which a protein or other ampholyte has zero mobility in an electric field; hence the pH at which the protein or other ampholyte has zero net charge, i.e., no charges or an equal number of positive and negative charges including those due to any extraneous ions bound to the ampholyte molecule. The pH value of the isoelectric point may depend on other ions, except hydrogen and hydroxide ions, present in the solution. Isoelectric point is also known as “isoelectric pH” (IEP or IpH).

Preferably, the isoelectric focussing in the module as described here takes place in reduced, or preferably the absence of electroosmotic flow. This may be achieved by use of suitable substrates, as described in further detail below.

Isoelectric Focussing (IEF) Module The isoelectric focussing module comprises a substrate (generally of a planar configuration) which has a channel. The isoelectric focussing module described here is sometimes also referred to as a “cartridge”, and the isoelectric focussing technique and module as “CIEF” (capillary isoelectric focussing).

Channel

The channel is of generally elongate disposition, and preferably linear. The channel may be tubular in construction, but is preferably open along at least a portion of its length. Preferably, the channel is open substantially along the whole of its length, so that it has the shape of a trough or open channel on the substrate.

The dimensions of the channel are generally in the order of the micrometre range. They are compatible with for example, microcapillary dimensions. By microcapillary or capillary, we refer to a narrow small diameter tube, preferably one which is capable of exerting capillary effects on a liquid, such as water. It will be appreciated that any capillary, such as a glass capillary (suitably modified as described below) or a plastic capillary, may be used for the purposes described here in place of the channel, provided that it is openable to expose and enable access to the separated components.

Preferably, the channel has a linear dimension, for example, width, depth or diameter of between 1 to 500 micrometres, preferably between 50 to 350 micrometres. However, in preferred embodiments, the channel has a linear dimension (preferably a width) of between 100 to 250 micrometres, or between 50 to 350 micrometers. In highly preferred embodiments, the channel has a linear dimension (preferably a width) of about 127 micrometers or about 150 micrometers or about 175 micrometres, most preferably about 175 micrometres. Where the channel is open, the depth of the channel is generally greater than its width.

The channel may be engraved or carved out of the substrate, or the module may be cast with the channel on it using known casting techniques with appropriate moulds. The channel may be burned on the substrate, for example using laser engraving. The channel may be melted, by use of an appropriate tensioned wire, for example a platinum wire which has been heated preferably by passing an electric current through it). Preferably, the channel is carved out of the substrate, as a groove. Machining techniques as known in the art may be employed for this purpose. In preferred embodiments, channel is excavated from the substrate such that the walls (or at least one wall of) the channel are comprised of the substrate material.

In highly preferred embodiments, a plurality of channels is disposed on the substrate. In preferred embodiments, the channel or channels are formed by laser etching, laser ablation, injection moulding or embossing of the substrate.

The phrase “laser etching” is intended to include any surface treatment of a substrate using laser light to remove material from the surface of the substrate. Accordingly, the “laser etching” includes not only laser etching but also laser machining, laser ablation, and the like. The term “laser ablation” is used to refer to a machining process using a high-energy photon laser such as an excimer laser to ablate features in a suitable substrate. The excimer laser can be, for example, of the F.sub.2, ArF, KrCl, KrF, or XeCl type.

The term “injection moulding” is used to refer to a process for moulding plastic or nonplastic ceramic shapes by injecting a measured quantity of a molten plastic or ceramic substrate into dies (or moulds). In one embodiment of the present invention, microanalysis devices may be produced using injection moulding.

The term “embossing” is used to refer to a process for forming polymer, metal or ceramic shapes by bringing an embossing die into contact with a pre-existing blank of polymer, metal or ceramic. A controlled force is applied between the embossing die and the preexisting blank of material such that the pattern and shape determined by the embossing die is pressed into the pre-existing blank of polymer, metal or ceramic. The term “hot embossing” is used to refer to a process for forming polymer, metal, or ceramic shapes by bringing an embossing die into contact with a heated pre-existing blank of polymer, metal, or ceramic. The pre-existing blank of material is heated such that it conforms to the embossing die as a controlled force is applied between the embossing die and the pre-existing blank. The resulting polymer, metal, or ceramic shape is cooled and then removed from the embossing die.

Open Channel

The isoelectric focussing module comprises means for exposing the channel along at least a portion of its length. Exposure of the channel in this manner thereby exposes the sample or component(s) therewithin, and allows them to be accessed, preferably for MALDI analysis. In highly preferred embodiments, the channel is an “open” channel, by which we mean that at least a portion, preferably a substantial portion, of the length of the channel is not closed or sealed. In other words, in such preferred embodiments, the channel adopts the configuration of a trough, being open on one long side. The opening should be at least as wide as necessary for access to the contents of the channel, for example the samples, and preferably the separated and focussed components of the samples, for example, proteins. Preferably, the length of the opening encompasses all or substantially all of the focussed components or proteins.

However, it will be appreciated that closed channels may be used, provided that they are provided with means for opening them. For example, closed capillaries may be employed for isoelectric focussing, if they are provided with fracture points to allow them to be split lengthways. Furthermore, a capillary may be formed by mating two planar members each comprising a groove. Isoelectric focussing may then be carried out within the capillary channel, following which the planar members may be separated for access to the focussed proteins.

Substrate

The substrate may be formed of any suitable material for isoelectric focussing, for example, plastics, polymers, ceramic, glass or composite materials, as known in the art. Generally, any non conducting material may be suitable for use as the substrate.

The substrate may be generally elongate, and preferably rectangular in shape. Although any size of the substrate may be employed, the term “substrate” as used here preferably refers to any material that can be microfabricated, e.g., dry etched, wet etched, laser etched, moulded or embossed, to have desired miniaturized surface features. In addition, microstructures can be formed on the surface of a substrate by adding material thereto, for example, polymer channels can be formed on the surface of a glass substrate using photo-imageable polyimide. Preferably, the substrate is capable of being microfabricated in such a manner as to form features in, on and/or through the surface of the substrate. Such preferred features include channels as described in further detail below.

The substrate can be a polymer, a ceramic, a glass, a metal, a composite thereof, a laminate thereof, or the like. By “composite” we mean a composition comprised of unlike materials. The composite may be a block composite, e.g., an A-B-A block composite, an A-B-C block composite, or the like. Alternatively, the composite may be a heterogeneous, i.e., in which the materials are distinct or in separate phases, or homogeneous combination of unlike materials. As used herein, the term “composite” is used to include a “laminate” composite. A “laminate” refers to a composite material formed from several different bonded layers of same or different materials. Other preferred composite substrates include polymer laminates, polymer-metal laminates, e.g., polymer coated with copper, a ceramic-in-metal or a polymer-in-metal composite.

Elements of the device, including but not limited to the plate comprising the channel(s) may be comprised of the substrate. Furthermore, the lid or cover plate where present may also be comprised of the substrate.

Particularly preferred substrates are those which display low electroosmotic flow (EOF). For example, materials whose surface groups are not substantially charged, for example plastics, are suitable for this purpose. Materials with charged surface groups may also be used, but are less preferred.

Glass capillary channels, for example, produce strong electro-osmotic flow (EOF) under applied electric field, while most of the plastic substrates do not have many ionizable chemical functional groups, and hence, exhibit very weak electro-osmotic flow (EOF) (Soper, S. A., Ford, S. M., Qi, S., McCarley, R. L., Kelly, K., Murphy, M. C., Anal. Chem. 2000, 72, 642A-651A). The EOF is an important driving force for moving chemicals inside the microchanel during capillary zone electrophoresis. However, the EOF has to be eliminated in capillary isoelectric focusing as described here for the formation of stable pH gradient by carrier ampholyte under the applied electric field (Wehr, T., Rodriguez-Diaz, R., Zhu, M., Capillary Electrophoresis of Proteins, Marcel Dekker, Inc., New York, 1999). Plastics substrates generally do not have many ionisable chemical functional groups, and they therefore exhibit weak electroosmotic flow (if any). Plastic substrates are therefore preferred as substrates.

Where materials with charged surface groups are used, for example, glass, surface charges should preferably be reduced by chemical modification in order to reduce EOF. Accordingly, glass and other similar substrates are preferably surface treated, derivatised or coated to reduce surface charges. Any material which is used for coating capillary channels in CIEF may be used for this purpose, for example acrylamide, hydroxypropyl cellulose, methyl cellulose, Teflon and polyvinyl alcohol.

The term “surface treatment”, including preferably derivatising or coating, is used to refer to preparation or modification of the surface of a substrate that will be in contact with a sample during separation, preferably one or more walls of the channel, whereby the separation characteristics of the device are altered or otherwise enhanced. Preferably, the characteristics of the device are enhanced to reduce electroosmotic flow. Accordingly, “surface treatment” as used herein includes: physical surface adsorptions; covalent bonding of selected moieties to functional groups on the surface of treated substrates (such as to amine, hydroxyl or carboxylic acid groups on condensation polymers); methods of coating surfaces, including dynamic deactivation of treated surfaces (such as by adding surfactants to media), polymer grafting to the surface of treated substrates (such as polystyrene or divinyl-benzene) and thin-film deposition of materials.

Protocols for coating with various materials are set out below. For acrylamide coating, the capillary or channel is washed with 0.5M NaOH for 30 minutes, then with water for 10 minutes. The capillary or channel is then washed with 0.1M HCl for 5 minutes, followed by washing with water for 30 minutes. A solution of 5 microliter/ml of gamma-methacryloxypropyltrimethoxysilane in 50:50 volume of water:acetone is made up, and the capillary or channel is washed for one hour in this. The capillary or channel is washed with 4% (w/w) acrylamide, 0.04% (v/v) N,N,N,N-tetramethylethylenediamine (TEMED) and 0.5 mg/mL ammonium persulphate solution for 30 minutes. Finally, the capillary or channel is washed with water and then dried by passing nitrogen through or across it.

For hydroxypropyl cellulose, methyl cellulose, or polyvinyl alcohol coating, any one of these chemicals can be added to the sample to achieve dynamic coating during isoelectric focussing. Alternatively, the capillary or channel is coated beforehand by washing capillary with 1-5% solution (of the appropriate chemical). The capillary or channel is then purged with dry nitrogen. The thin layer of coating is then immobilized on the capillary by heating it to 140-160 degrees C.

While the above protocols may be conducted on the capillary or channel itself, it will be appreciated that it is possible, and may be more convenient, to treat entire substrate with the channel for this purpose.

Where glass substrates are used, and microfabrication techniques for example as commonly known in the microelectronics industry, may be employed to engrave or etch the channel on the glass substrate. Polymer substrates are also amenable to microfabrication technologies, and such technologies are described in detail in Becker, H., Gärtner, C., Electrophoresis 2002, 21, 12-26. For example, the plastic devices can be produced from injection moulding, laser ablation, imprinting or hot embossing. Such fabrication techniques allow the device to be replicated quickly for mass production with inexpensive methods. These allow the use of single use disposable devices in medical diagnostics and screenings.

In highly preferred embodiments, the substrate is made of poly(methylmethacrylate) (PMMA) or polycarbonate, and at least one wall of the channel comprises this material.

Carrier Ampholyte

Carrier ampholytes are a heterogeneous mixture of synthetic polymers incorporating a variety of both acidic and basic buffering groups. Ampholyte molecules have net charges that depend on the pH of the environment and the number and pKs of the particular mixture of acidic and basic groups on the particular molecule. For isoelectric focusing (IEF), carrier ampholytes are introduced into the channel. In the absence of an electrical field, the carrier ampholytes are randomly distributed and establish a uniform pH throughout the gel matrix, about pH 7 when creating a pH 3-10 gradient.

When an electrical field is applied across the channel, usually through an acid electrode solution at the anode (+) and a basic electrode solution at the cathode (−), all carrier ampholytes with a net charge will start to migrate. Those with a net negative charge and low pI value move toward the anode, those with a net positive charge and a high pI value move toward the cathode, and those with no net charge (neutral) do not move. The ampholytes with the more extreme pI values can migrate closer to the appropriate electrode solution before they are titrated to the pH equal to their pI. Thus the pH gradient is established by the mobile carrier ampholytes. At equilibrium, the pH at any point in the gel is determined by the average pI of the soluble carrier ampholytes at that point. At the same time, charged or neutral molecules, such as protein components of the sample, also move to their pI points, and are focused.

The carrier ampholytes may be introduced into the channel, and an electric field applied to create a pH gradient. Alternatively, or in addition, the carrier ampholytes are mixed into the sample, and the sample containing the carrier ampholytes is introduced into the channel.

Under the influence of the electrical force the pH gradient will be established by the carrier ampholytes, and the protein species migrate and focus (concentrate) at their isoelectric points. The focusing effect of the electrical force is counteracted by diffusion which is directly proportional to the protein concentration gradient in the zone. Eventually, a steady state is established where the electrokinetic transport of protein into the zone is exactly balanced by the diffusion out of the zone.

A large number of carrier ampholyte mixture are available giving different pH gradients. The optimal pH gradient will depend on the purpose of the experiment. For screening purposes, a broad range interval (pH 3-10 or similar) may be used. A narrow pH range interval is useful for careful pI determinations or when analyzing proteins with very similar pI points. Generally, one should not use a narrower gradient than necessary because the shallower gradient will lead to longer focusing times and more diffuse bands. When choosing pH gradient one should be aware that the interval stated by the manufacturer can only be an approximation. The exact gradient obtained depends on many factors such as choice of electrolyte solutions, gradient medium (PAA or agarose), focusing time etc.

Carrier ampholyte free CIEF has been demonstrated (Huang, T., Wu, X-Z., Pawliszyn, J., Anal. Chem. 2000, 72, 47584761), and it is possible to use the methods described in Huang and Pawliszyn for the isoelectric focussing technique described here. Furthermore, it will be appreciated that the pH gradient in the channel can also been generated by immobilizing acidic or basic ampholytic molecules on the open channel surface. This is described in detail in Rosengren, A., Bjellqvist, B., Gasparic, V., U.S. Pat. No. 4,130,470, 1978. However, the use of carrier ampholytes is preferred.

A carrier ampholyte which may be used for the isoelectric focussing using the module and apparatus described here is Pharmalyte 3-10, or BioRad 3-10. This may be used typically from 0.8% to 4% or more, preferably about 1%. Carrier ampholytes are described in detail in U.S. Pat. No. 4,131,534.

Glycerol is a common additive for IEF, as it can prevent proteins precipitation when proteins concentration increase around their pI points. The glycerol is also an infrared (IR) MALDI matrix for protein ionization. The use of glycerol is preferred in the isoelectric focussing techniques when it is coupled to IR-MALDI-MS.

Mass Spectrometry

(The text in this and the next section describing MALDI-MS and -TOF is adapted from an article in The Scientist 13 [12]: 18, Jun. 7, 1999).

The methods described here typically employ separation using IEF in a first dimension, and separation by mass in a second dimension. The mass separation is preferably carried out by mass spectrometry. The IEF module is preferably coupled to a mass spectrometer for separation and detection in the second dimension.

Mass spectrometry (MS) systems typically employ components for smashing and ionizing the target molecules by applying energy and for analyzing the results. Typically, the molecules are ionised by bombardment with an electron beam, high-energy ions, or a laser. Ionization charges some of the sample molecules, which can either remain intact or fragment into a variety of charged and neutral particles. The ions are accelerated by an electrostatic or magnetic field in the mass analyzer and separated by deflection or time of flight to the detector. Some mass analyzers can differentiate between oxygen at 15.999 Da and the similarly sized NH2 ion at 16.021 Da. Mass accuracy is generally cited in parts per million (ppm), and many systems claim mass accuracies of ˜100-200 ppm. A review of the considerations for designing mass analysers is provided by Brunee Journal of Mass Spectrometry and Ion Processes, 76:125-237).

Two types of ion detectors are typically employed in mass spectrometers: electron multipliers and microchannel plates. Both technologies are well suited to ion detection., although electron multipliers (which consist of several layers of charged dynodes) are considered more stable to high ion flux.

The first widely available configurations for MS included an electron beam ionization source, a scanning quadrupole mass filter, and a multidynode ion detector and were suited primarily for analysis of smaller molecules. MS first became useful for protein research when fast atom bombardment (FAB) ionization sources were designed to smash larger molecules (including proteins and peptides up to ˜10 kDa) into manageable pieces. FAB uses a high-energy (5-10 keV) stream of inert gas particles to “ballistically ionize” the sample. It is limited by a relatively poor efficiency of target ionization and can lead to high backgrounds when the ionizing particles themselves break up, ionize, and impact the detector.

Electron spray ionization (ESI) increased the protein mass range to ˜100 k Da. Quadrupole and magnetic sector ESI MS became very valuable tools. ESI uses a high electric field to aerosolize a solution of the target analyte; the droplets subdivide until they contain a single analyte molecule that carries a residual charge. Often, ESI-productions carry multiple charges, which can be a benefit or a problem, depending on your instrument and application. Neither FAB nor ESI is suited to working with samples in bulk form or on a solid support.

For proteins, ESI MS has in many ways been superseded by MALDI as the hammer and by time-of-flight mass analyzer tubes as the detector. The methods and apparatus described here preferably employs a MALDI mass spectrometer for separation and detection in the second dimension.

Matrix-Assisted Laser Desorption/Ionization (MALDI)

Matrix-assisted laser desorption/ionization-time of flight (MALDI-TOF) mass spectrometry is a tool for large-molecule analyses, especially for proteins. MALDI-TOF is capable of distinguishing protein and nucleic acid sequence, structure, purity, heterogeneity, cleavage, posttranslational modification, and other molecular characteristics that are often difficult to study by other means. MALDI is described in detail in Chapman, J. R, Mass Spectrometry of Proteins and Peptides, 2001, Humana Press, Dass, C., Principles and practice of biological mass spectrometry, 2001, John Wiley & Sons, James, P., Proteome research: mass spectrometry, 2001, Springer, Kellner, R, F. Lottspeich, and H. E. Meyer, Microcharacterization of Proteins, 2nd Ed, 1999, Wiley-VCH, Kinter, M., and N. E. Sherman, Protein Sequencing and Identification Using Tandem Mass Spectrometry, 2000, Wiley Interscience and Siuzdak, G., Mass Spectrometry for Biotechnology, 1996, Academic Press.

MALDI uses pulses of laser light to desorb the analyte from a solid phase directly to an ionized gaseous state. Pulsed lasers had been used to ionize proteins prior to 1988, but the technique was limited due to protein light absorption. A metal powder matrix for laser desorption and ionization of analytes was first presented in 1987 by Koichi Tanaka and colleagues (K. Tanaka et al., Shimadzu Corp., Kyoto, Japan, “Proceedings of the 2nd Japan-China Joint Symposium on Mass Spectrometry,” 185, 1987).

The more common MALDI method using an organic photoactive compound was published in 1988 by Michael Karas and Franz Hillenkamp (M. Karas, F. Hillenkamp, “Laser desorption of proteins with molecular masses exceeding 10,000 Daltons,” Analytical Chemistry, 60:2299, 1988) and has been more recently reviewed by Ronald Beavis and Brian Chait (R. C. Beavis, B. Chait, “Matrix assisted laser desorption ionization mass-spectrometry of proteins,” Methods in Enzymology, 270:519, 1996).

In MALDI, the protein is embedded in a medium or matrix by cocrystllization with a photoactive compound such as gentisic acid, 4-HCCA (alpha-cyano-4-hydroxycinnamic acid), or dithranol. The typical matrix for use with ultraviolet lasers is an aromatic acid with a chromophore that strongly absorbs the laser wavelength. Other laser wavelengths are possible, in particular the mid-infrared range where the matrix can be energized by vibrational excitation; different matrix compounds must be used in this case. The MALDI matrix must meet a number of requirements simultaneously: be able to embed an isolate analytes (e.g., by co-crystallization), be soluble in solvents compatible with analyte, be vacuum stable, be able to absorb the laser wavelength, cause co-desorption of the analyte upon laser irradiation and promote analyte ionization.

The matrix compound absorbs the light and uses the energy to eject and ionize the embedded protein molecules. As the protein does not fragment during desorption, MALDI is often referred to as being a “soft” ionization technique. The list of suitable matrix compounds for MALDI is extensive, and include Cyano-4-hydroxyciminamic acid (CHCA), 2,5-Dihydroxy benzoic acid (DHB), Alpha CCA, Sinapinic Acid (SA), 3-hydroxypicolinic acid (HPA), IAA (Na+), 2-(4-Hydroxyphenylazo)benzoic acid HABA (Na⁺), Dithranol (Na⁺), Retinoic Acid (Na⁺), Succinic acid, 2,6-Dihydroxyacetophenone, Ferulic Acid, Caffeic acid, Glycerol and 4-Nitroaniline. Preferably, the matrix is added to the dried sample after isoelectric focussing. Alternatively, or in addition, the matrix may be added to the sample such that it is present during the isoelectric focussing.

Although other options are available, most MALDI techniques typically illuminate at about 20 mJ cm⁻² using nitrogen lasers (337 nm) or Q-switched neodymium:yttrium-aluminum-garnet (Nd—YAG) lasers with frequency tripled to 355 nm or quadrupled to 266 nm. Longer wavelengths are favored for protein work because they are less readily absorbed.

Magnetic sector and quadrupole mass spectrometers work by accelerating a stream of ionized sample along a vacuum tube toward an electrostatic or magnetic field that deflects or filters particles based on momentum or mass-to-charge ratio (m/z). A good review of MS detectors can be found in Brunee (1987, International Journal of Mass Spectrometry and Ion Processes, 76:125-237).

In time of flight mass spectrometry (TOF MS), the ionized analyte molecules and fragments are accelerated in an electrostatic field to a common kinetic energy. If all the ions have the same initial kinetic energy, lighter ions travel faster and heavier ions with the same momentum travel more slowly. The ionized particles enter at one end of the time-of-flight tube, which typically comprises a long, empty tube for free flight, and the number of ions reaching a detector at the other end is recorded in a time-dependent manner. Assuming all the ions have the same electrical charge, the lightest ions reach the detector first and the heaviest arrive last The entire mass spectrum is typically recorded in a fraction of a second as ion flux versus time.

For TOF to work, the time at which the ions leave the source must be precisely controlled and defined. While MALDI ionization techniques have been coupled with quadrupole ion and magnetic sector mass analyzers, the commonest modern combination is with time-of-flight tubes, because the ionization event automatically provides the start pulse for the clock. The short duration of laser pulsing makes MALDI a particularly suitable match for TOF MS. Typically, flight-tube lengths are a couple of meters and flight times are ˜100 ms-thousands of times longer than the nanosecond laser pulses.

The mass range of a TOF instrument is generally limited by the detector technology employed. The high m/z ions end up travelling very slowly and are very poorly detected by conventional detectors. Instruments such as GSG Analytical Instruments' Future MALDI-TOF spectrometer extend the mass range of MALDI-TOF out to 1,000,000 Da with the help of a two-stage detector that captures the high m/z particles more effectively and a fast (1 GHz) digitizer to increase resolution. Accordingly, such instruments are preferred for use in detecting high molecular weight entities in the methods and apparatus described here.

The simplest TOF instruments have a linear configuration, with the detector placed at the end of the flight tube; this is a typical configuration in MALDI-TOF instruments which are currently available.

During sample desorption and ionization, analyte particles can leave the surface of the protein-matrix cocrystal with a small but variable amount of kinetic energy in addition to the energy imparted by the acceleration process. This variable kinetic energy has the effect of “smearing” the mass-to-charge ratio of a specific analyte fragment over a small time range, decreasing the signal-to-noise ratio and broadening the analyte bands, but it can be largely eliminated in a couple of ways. The first is time lag focusing or delayed extraction, in which newly formed ions are held close to the surface of the protein-matrix cocrystal with a low voltage (generally 1 keV or so) pulse before applying the main acceleration pulse (generally 20-30 keV). Most instruments now incorporate this feature. Time lag focusing or delayed extraction is described in further detail in W. C. Wiley, I. H. McLaren, Review of Scientific Instruments, 26:1150-7, 1955 and B. Spengler, R. J. Cotter, “Ultraviolet laser desorption/ionization mass spectrometry of proteins above 100,000 Daltons by pulsed ion extraction time of flight analysis,” Analytical Chemistry, 62:793-6, 1990.

The second way to focus an ion band is to change the TOF geometry by adding a reflectron to the end of the flight tube and moving the detector(s). A reflectron or “ion mirror” consists of a series of electrostatic and magnetic fields that collect and redirect the ions in a controlled manner. Ions with a given m/z slow down as they approach the reflectron mirror, focus into a tighter packet, and are then repelled either at an angle toward a detector at the end of a second stage of flight tube or backward along the same tube to a detector placed near the ion source. For many applications, reflectron-based TOF tubes give sharper signals by reducing the effects of initial kinetic energy differences.

Because reflections effectively increase—almost double—the TOF free-flight path, they increase resolution and therefore improve mass accuracy. Reflectron technology also allows researchers to study molecular structure of ions via postsource decay, in which ionized fragments decompose further in the flight tube and the secondary products provide additional information about the structure of the original ion. The information gained from postsource decay detection is similar to that provided by tandem MS (MS/MS), where ions are intentionally refragmented after passage through a mass analyzer and the secondary fragmentation products are examined in a second mass analyzer.

Examples of reflectron-based MALDI-TOF instruments include Comstock's RTOF-260 instrument, which is a reflectron-based version of its LTOF-160. PerSeptive Biosystems (a division of PE Biosystems) offers the Voyager DE™ workstation, 4700 TOF/TOF and the Voyager DE-PRO.

Micromass and Kore produce the TofSpec-2E and R-500 TOF MS, respectively. The M@LDI, made by Micromass, may also be used.

The several reflectron systems offered by Bruker Daltonics, including the customizable REFLEX m system and the BIFLEX III system for high-end research, the Autoflex and the Ultraflex, may also be used.

Reflectron-based instruments, such as the Kompact DISCOVERY and the Kompact SEQ, made by Kratos Analytical, a Shimadzu company, may also be used Kratos' reflectrons have a design incorporating a curved field rather than stepped or tiered linear fields. In normal ion reflection configurations, many of the postsource decay ions are “out of time-focus” and are therefore lost. Most instruments collect only about 10 percent of the range of postsource decay particles, necessitating repeated experiments at different collection points. The curved field allows collection of the entire range of postsource decay products from one laser pulse without rastering or scanning and eliminates the need to compile data from sequential experiments. Shimadzu also produces the AXIMA-CFR-plus and AXIMA-QIT.

Multisample target formats are becoming more important to users, and many companies have started to offer them. For example, BioMolecular Instruments, a division of Thermo BioAnalysis, recently introduced the Dynamo, which is highly automated and incorporates a video camera in the ionization chamber for direct sample monitoring. The Bruker REFLEX III and BIFLEX III instruments both offer integration with Bruker's SCOUT 384 automated sampler. The SCOUT 384 uses standard microtiter plate formats and an X-Y positioner with 4 mm accuracy for unattended data acquisition from up to 1,536 samples.

It will be appreciated that other MALDI mass spectrometers, other than MALDI-TOF spectrometers, may be used. For example, FTMS (Fourier Transform Mass Spectrometers) may also be used or combined with the module as described here.

### Specific Embodiments

Preferred embodiments of the present invention will now be described with reference to the accompanying Figures, wherein like numerals refer to like elements throughout. The terminology used in the description presented herein is intended to be interpreted in its broadest reasonable manner, even though it is being utilized in conjunction with a detailed description of certain specific preferred embodiments of the present invention. This is further emphasized below with respect to some particular terms used herein. Any terminology intended to be interpreted by the reader in any restricted manner will be overtly and specifically defined as such in this specification.

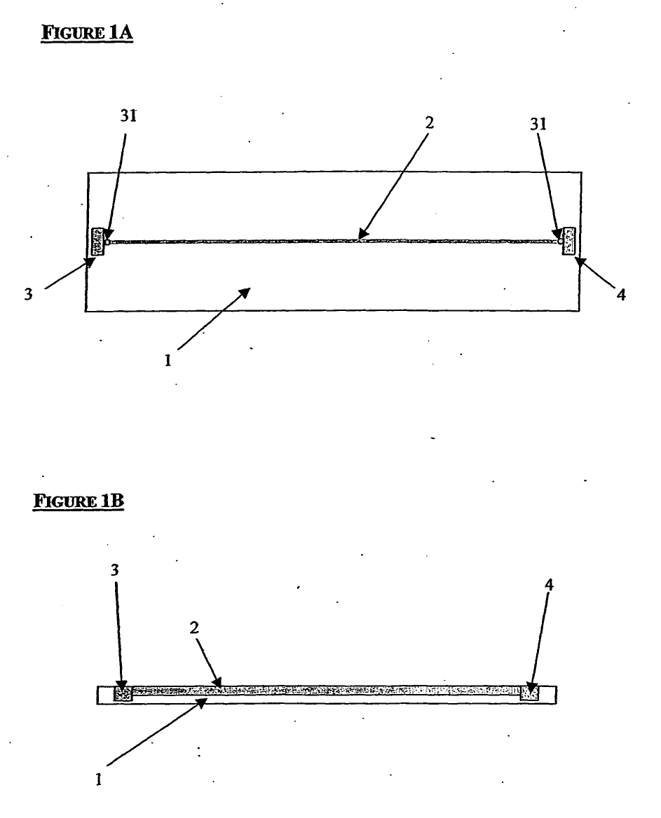

FIGS. 1A and 1B show a first embodiment of the isoelectric focussing module with a single microchannel. Module comprises a substrate 1 of generally planar configuration, made of poly(methylmethacrylate) (PMMA) or polycarbonate. The substrate 1 comprises a piece of a PMMA plate having dimensions of 90 mm×30 mm×3 mm. A channel 2, which in this embodiment is an open channel, is carved, built or etched out of the substrate. Reservoirs 3 and 4 machined from the substrate and are positioned at opposite sides of the channel and carry electrolyte (anolyte and catholyte). The reservoirs 3, 4 are separated from the open channel by agarose plugs 31. The agarose plugs are set in the boundary of the reservoir and the channel, and allow electrical conductivity to be maintained between the electrolyte solution and the contents of the channel (typically a sample to be separated, see below). Mixing between the contents of the channel and the reservoir is prevented, however, by the presence of the agarose plugs. Mixing may also be prevented by the use of a gel plug, such as an acrylamide gel plug or an agar gel plug, or any other suitable gel plug which prevents mixing but conducts electricity. Mixing may be prevented by increasing the viscosity of the sample, by for example, adding glycerol to it The viscosity of the electrolytes, or one or both of the anolyte and catholyte, may be increased alternatively, or in addition to increasing the viscosity of the sample. For example, methylcellulose may be added to the or each electrolyte(s).

It will be understood that the presence of the agarose or gel plug is optional, provided that mixing is minimised. For example, the channel may have a narrower profile at the region where it joins the reservoir; the narrow portion will substantially reduce convection and therefore any mixing between the components of the channel and the reservoir.

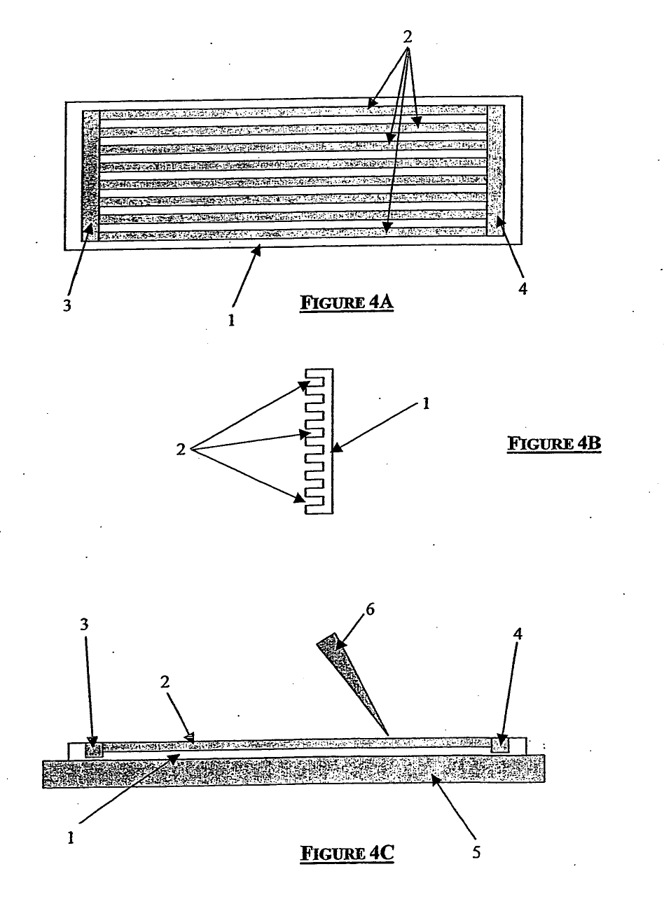

FIGS. 4A to 4C show a second embodiment of the isoelectric focussing module, which contains multiple channels 2. Each of the channels in this embodiment may be fabricated as described above for the single channel embodiment. In a preferred embodiment, the channels are parallel with each other, or substantially so. The channels may each have individual reservoirs 3, 4 connected to them, or preferably may be joined at each end to a common reservoir 3, 4 shared by all the channels. As described above, each channel may preferably have an agarose gel or plug, preferably at each end, to reduce mixing with the electrolyte contents of the reservoir.

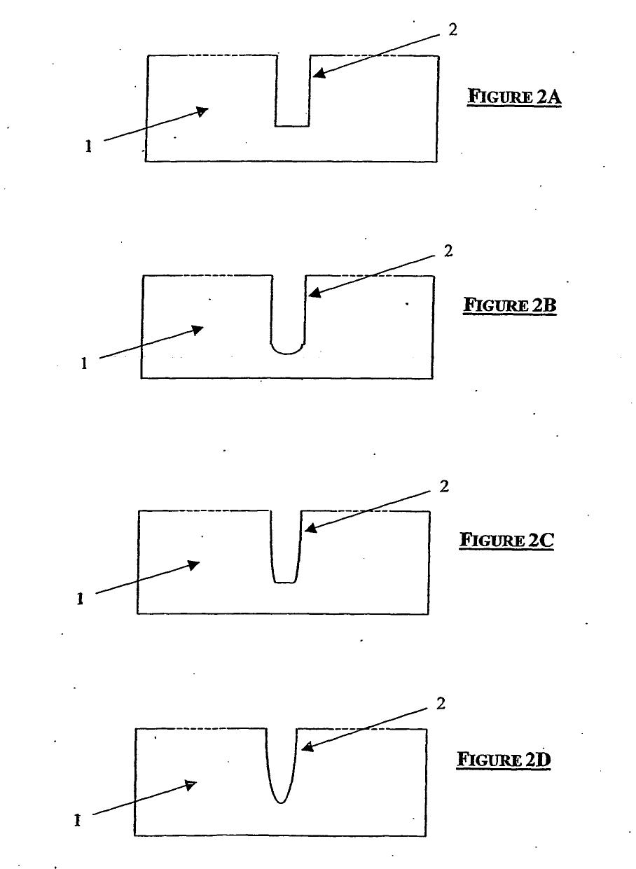

The channel or microchannel 2 can have a variety of shapes or profiles; indeed, any profile which is conducive to isoelectric focussing and open at one edge may be used. Examples of individual channel profiles are shown in FIGS. 2A to 2D. Thus, the channel 2 may have a flat bottom and straight walls, so that it adopts a flat U shape (FIG. 2A). The channel 2 may have a curved or bowed or convex profile, and straight walls, thus having a typical “U” shape (FIG. 2B. The channel 2 may have curved walls and a straight base (FIG. 2C) or substantially curved walls adopting a curved “V” shape (FIG. 2D). A variant of the profile of FIG. 2D, with straight walls, i.e., a straight “V” shape, may be employed. In each of these cases, the channel may be carved, etched, or gouged out of the substrate 1. FIG. 4B shows a profile of the module in a second embodiment of the device, showing the multiple channels 2 on the substrate 1.

In the first and second embodiments described above, the reservoirs 3, 4 are provided on the same piece of substrate as the channel, i.e., they are provided “in cis”.

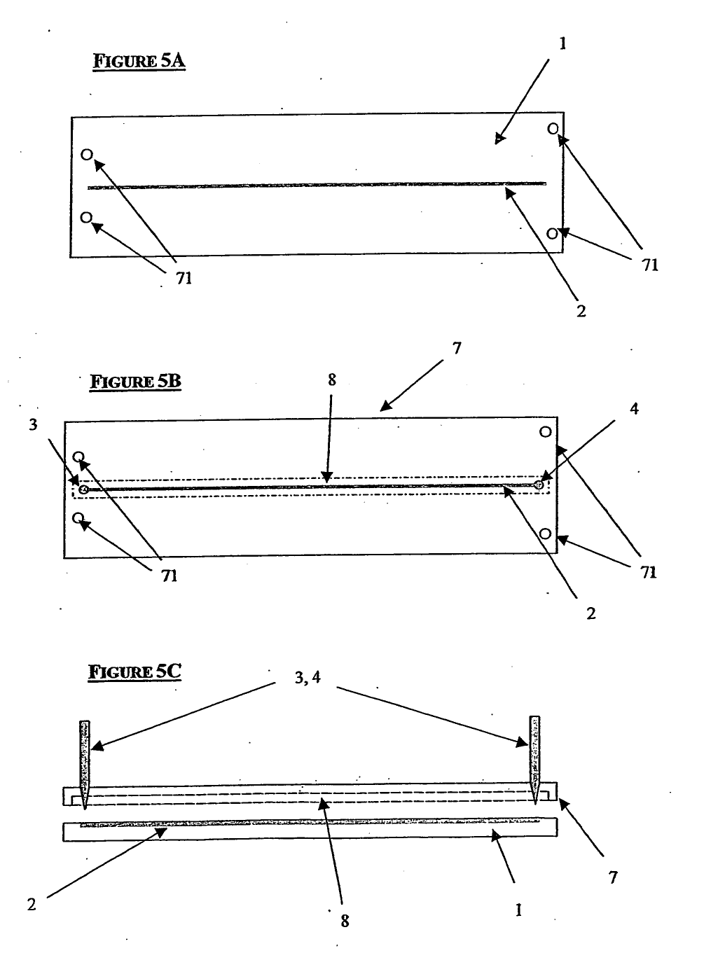

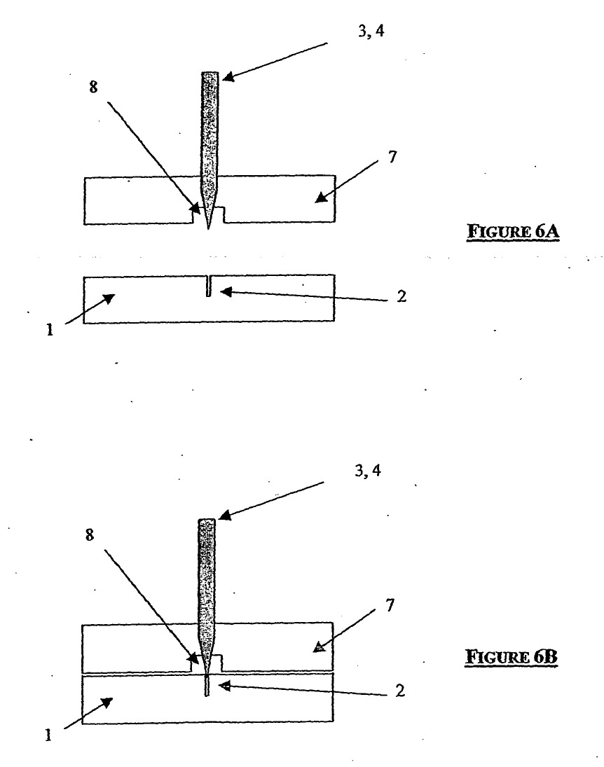

In other embodiments of the module or device, however, the reservoirs are not located on the same substrate as the channel. Rather, they are provided on a separate lid or cover plate 7, as illustrated for a third embodiment in FIGS. 5A to 5C. As can be seen from FIGS. 5B and 5C, a separate cover plate or lid 7 is provided to hold the reservoirs 3, 4. The reservoirs 3 and 4 may be provided as tubular compartments, which are capable of holding electrolyte. They may for example have a conical shape, or a cylinder having a conical end. In the embodiment shown in FIGS. 5A to 5C, the electrolyte reservoirs are modified from a micropipette with a sharp tip of about 10 μm. They are attached to the cover plate as shown in FIGS. 5C, 6A and 6B. In such embodiments, the reservoirs 3, 4 can be said to be provided “in trans”.

The tips of the micropipettes are filled with a thin layer of agarose gel to prevent mixing of the electrolytes and the sample while allowing ions to migrate through the junction It will be seen from FIGS. 5C, 6A and 6B that distal portions of the reservoirs 3, 4 extend across the lid 7, and mate with respective ends of the channels 2 when the lid is placed on the substrate 1. For this purpose, suitably sized and positioned holes may be drilled on the lid 7 to hold the reservoirs 3, 4 in position.

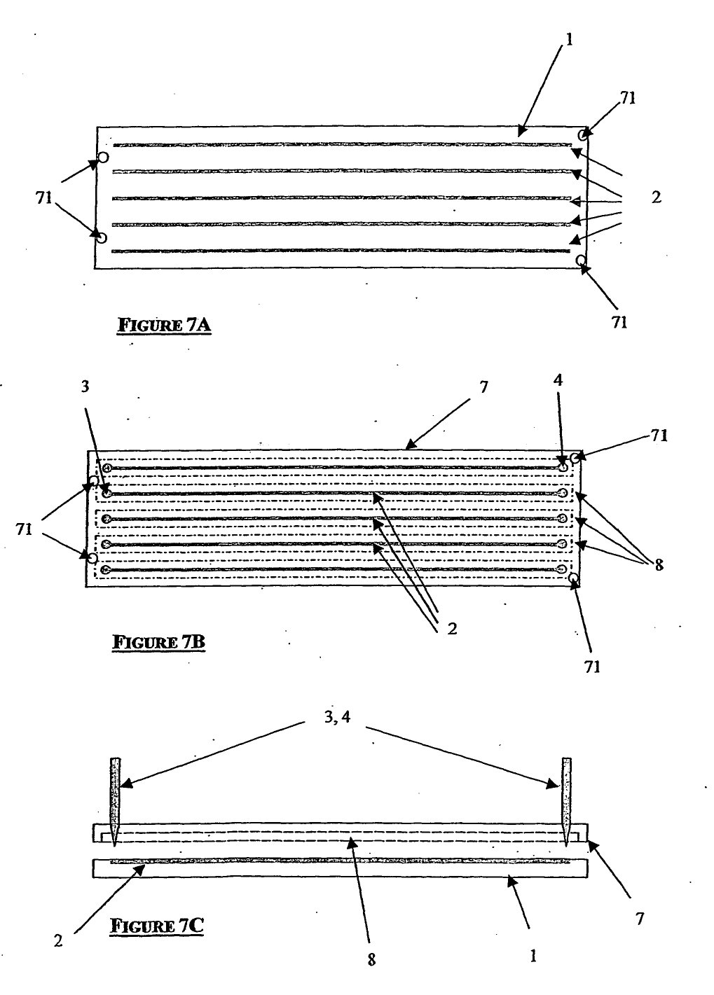

The lid or cover plate 7 and the base 1 may further comprise guiding means 71, as shown in FIGS. 5A, 5B, 7A and 7B for guiding the lid 7 to overlay the base or substrate 1. The guiding means may comprise markings on the lid 7 and substrate 1, or preferably physical guiding means such as a peg and hole arrangement, a tongue and groove arrangement, etc. Preferably, the lid 7 comprises a hole 71 and the base or substrate 1 comprises a peg or post 71 (or vice versa). The guiding means enables precise alignment between the base and the lid, so that the channels and recesses are matched to their correct positions, and the outlets of the electrolyte reservoirs are pointed to the channels. Preferably the guiding means 71 is asymmetrically placed on the lid and base, so that the two can only be mated in one orientation.

The cover plate 7 preferably is not completely flat, particular at points abutting the channel or channels. This is because a completely flat cover plate would cause the sample in the microchannel 2 to contact the cover plate 7 and thereby diffuse out of the channel to the gap between two plates by capillary action. Accordingly, in a preferred embodiment, the lid or cover plate 7 comprises one or more grooves or recesses 8, preferably the same number of recesses as there are channels, on one face (i.e., the face which abuts the microchannels when the lid is in place). The or each groove or recess is positioned such that when the lid is mated with the first planar member, no substantial leakage of sample contained in the channel occurs. Preferably, the length and width of the recess or recesses are at least as great as a channel or respective channels in the first planar member. The grooves may be machined on the corresponding opposite side of the microchannel on the cover plate to prevent the sample from diffusing out to the gap. The arrangement of recesses 8 on the cover plate 7 is shown in FIGS. 6A (lid open) and 6B (lid closed).

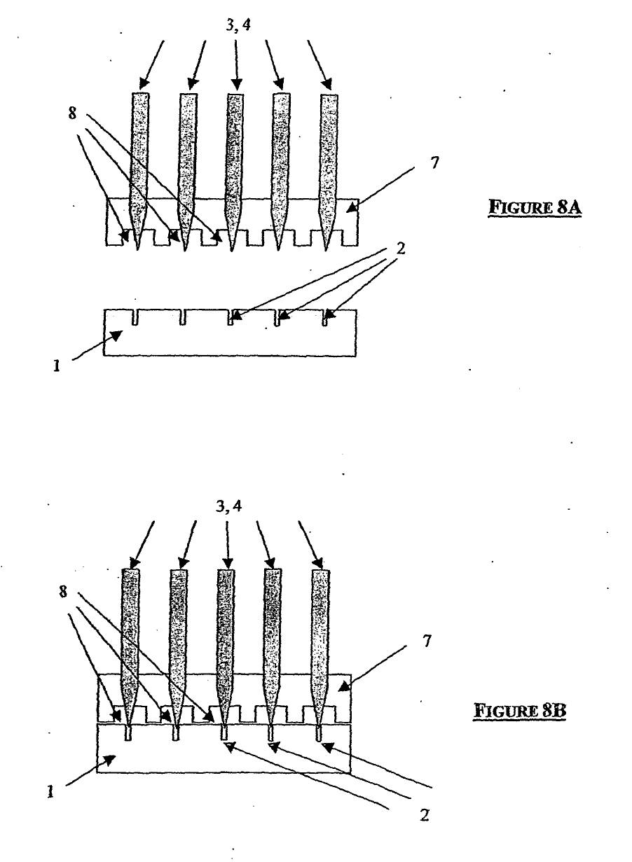

FIGS. 7A to 7C show a fourth embodiment of the isoelectric focussing module, which is identical with the third embodiment except that it contains multiple channels 2. Each of the channels in this embodiment may be fabricated as described above for the single channel embodiment In a preferred embodiment, the channels are parallel with each other, or substantially so. The reservoirs 3, 4, serving the channels are located on a separate lid or cover plate 7, as described above. Each reservoir may preferably have an agarose gel or plug, to prevent or reduce mixing between the electrolyte contents of the reservoir, and the contents of the channels. A profile showing the arrangement of the multiple reservoirs 3, 4 on the lid 7, and the recesses or grooves 8, together with the substrate 1 comprising multiple channels 2, is shown in FIG. 8A (lid open) and FIG. 8B (lid closed).

The use of a lid in the third and fourth embodiments is advantageous in that it reduces evaporation of the sample in the channel or channels. Evaporation is a particular problem because of the small volume and large surface area of the sample in the channel. The lid maintains a humid atmosphere above the sample, and prevents drying out. Furthermore, the presence of a cover also prevents carbon dioxide from the air dissolving into the sample, and perturbing the pH gradient established.

It will be appreciated, however, that the presence of a cover is not strictly necessary, and other means may be used to control drying and pH perturbation. For example, isoelectric focussing with embodiments one and two with open channels may be carried out in a controlled atmosphere, particularly one with humidity conducive to non-evaporation (i.e., one high in humidity—high relative humidity). Therefore, a humidity controlled chamber may be used. Furthermore, the controlled atmosphere may be depleted of carbon dioxide. For this purpose, a simple air-tight chamber may be used; the chamber may contain a carbon dioxide depleting agent, such as an alkali metal hydroxide (NaOH, KOH) or an alkaline metal hydroxide (Ca(OH)₂), or other chemicals such as NaCO₃, etc. The chamber may comprise a mister, or simply a source of water, for maintaining high humidity.

Furthermore, or alternatively, evaporation may be reduced by reducing the vapour pressure of the solvent in the sample, for example by cooling. For this purpose, the temperature of the module or the substrate, or its surroundings may be reduced. For this purpose, the cartridge or module is mounted on an aluminium block which in turn was immersed in an ice bath. The temperature can also be controlled by attaching the cartridge or module onto a thermoelectric cooler.

For isoelectric focussing in the module, anolyte and catholyte are introduced into the reservoirs. 100 mM potassium hydroxide in 1.5% methylcellulose is used as catholyte and 50 mM phosphoric acid in 1.5% methylcellulose is used as anolyte. A sample—for example a sample containing proteins such as a cell extract—is introduced into the channel. As the module and device are particularly useful for separation and analysis of proteins in cell, tissue, or organ samples, the following description will be based on separation of such proteins in cellular samples.

The sample may contain a carrier ampholyte as known in the art, and as described above. A voltage of from about 500V to 5 kV is then applied across the channel 2 by means of electrodes introduced into the reservoirs 3 and 4. For this purpose, the module or apparatus may comprise a power supply (not shown), which is capable of generating an electrical potential between two points, preferably the electrodes 3, 4. The power supply is preferably a DC power supply, as known in the art for use in electrophoresis devices. Examples include, but are not limited to, PowerPac Basic power supply, PowerPac 3000 power supply, PowerPac 1000 power supply, PowerPac 200 power supply, and PowerPac 300 power supply, produced by BioRad. Other suitable power supplies include the EC105 Power Supply, EC135-90 Power Supply, EC250-90 Power Supply, EC4000P Programmable High Voltage Power Supply, EC570-90 Power Supply, EC600-90 High Voltage Power Supply, EC6000-90 High Voltage Power Supply, EC PRO6000 Power Supply, EC1000-90 Power Supply, made by Thermo EC (Thermo Savant/Thermo EC Holbrook, N.Y., United States).

The power supply may be linked to the electrodes 3, 4 by means of wires. The power supply may further comprise control means, by which an operator is able to control various parameters. For example, the control means may allow the operator to vary the potential difference (voltage). The control means may enable the current to be modified, for example, the current across the channel. Control of the voltage and current is advantageous because it enables the amount of Joule heating (voltage×current) to be adjusted.

Application of the voltage across the channel causes a pH gradient to develop along it, as described in detail above. The molecules, proteins or other components of the sample then migrate along the channel and are focussed at points according to their respective pI points. Isoelectric separation and focussing of the components therefore takes place along the channel.

The voltage is applied for a suitable amount of time to allow focussing, for example, about 5 minutes. Protein focussing into a narrow zone is indicated by a drop in the focusing current to a constant value. Following this, the voltage applied across the capillary channel may be gradually increased to tighten the focusing zones. The use of modules comprising multiple channels (e.g., embodiments two and four described above) is advantageous, as many different samples may be processed at the same time. Migration and focussing of the proteins may also be monitored by means of suitable stains.

After the proteins are separated, the sample is dried to retain the separated components of the sample, for example proteins, at the points at which they are focussed. Any suitable means for removing the solvent in the sample may be used, for example, application of a stream of warm air, preferably dry air over the module. Lyophilisation, vacuum drying or freeze drying, may also be employed for this purpose. Application of an electrical potential across the channel, which causes Joule heating, may be employed to evaporate the solvent. Proteins “frozen” in position are accessible because of the open nature of the channel, and may then be analysed by any suitable means. In preferred embodiments, a mass spectrometry technique is used to analyse the proteins, for example MALDI-TOF. For this purpose, and as noted above, the MALDI matrix may be added to the sample. Alternatively, it may be applied to the dried focussed proteins in the channel.

The isoelectric focussing module may or may not then be coated with an electrical conducting thin film or layer by different means before performing MALDI-MS. The conductive coating may be achieved by vacuum deposition of metallic or conductive layer, or by painting a layer of conductive material, or by use of conductive adhesive tape, or by other methods. In the preferred embodiment, the isoelectric focussing module is not coated with any conductive coating.

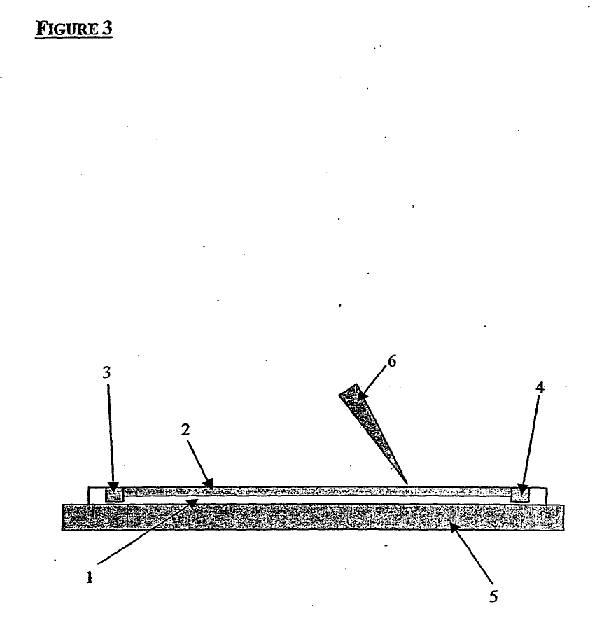

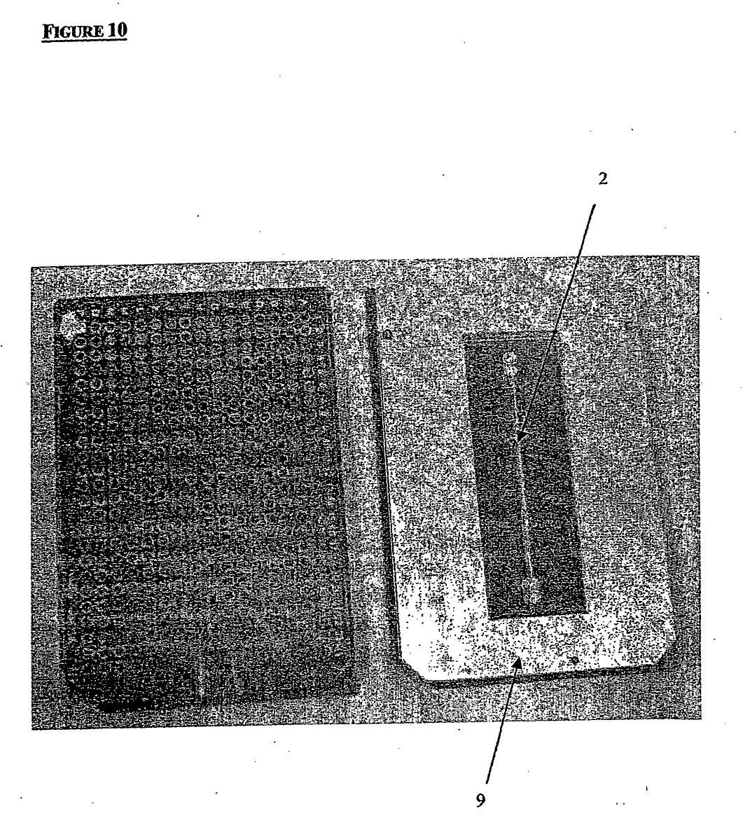

The isoelectric focussing module (including substrate comprising the channels) is then mounted on a standard MALDI plate for the MALDI procedures. The cartridge may therefore be loaded into a translational stage, for example an X-Y translational stage, in the MALDI ionization source. The isoelectric focussing module may be mounted directly on the MALDI plate, or the isoelectric focussing microchannel may be fabricated directly on the MALDI plate, or an adapter may be fabricated to hold the isoelectric focussing module onto the MALDI plate. FIG. 3 (and also FIG. 4C) shows a cross section of a module comprising the planar substrate and channel, which is mounted on a stage or adapter 5. The adaptor 5 is also depicted in FIG. 10. The MALDI laser 6 is then focussed on the centre of the channel or microchannel, and the MALDI plate is moved slowly across the laser 6, while maintaining the laser beam 6 on the centre of the channel. The translational stage may be moved to consecutively bring the whole open channel to the focused laser spot. The MALDI laser 6 ionizes the proteins, and analysed using time of flight (TOF) or other means as described in detail above. The protein molecular ions from the MALDI source may be fragmented by post source decay or collisionally activated dissociation for protein identification.

In highly preferred embodiments, the separation of protein samples in open channels is preferably done in parallel format where multiple microchannels are built on a cartridge. Such embodiments are the second and fourth embodiments, illustrated in FIGS. 4A-C and 7A-C.

The parallel CIEF separation can take less than 5 minutes. The detection of protein in the second dimension requires scanning the channel over the focused laser in the MS ionization source region. How fast the channel for MALDI ionization may be moved depends on the repetition rate of the desorption/ionization laser. Nitrogen lasers commonly used in MALDI normally operate at 10-20 Hz. However, diode-pump solid state lasers can operate in several kHz repetition rates, and are therefore preferred. Therefore, in such preferred embodiments, a complete scan of the whole channel using such lasers can be completed within minutes. High throughput, high sensitive protein separation and characterization through their pI points and molecular weights can be achieved using our apparatus with minimal sample consumption for clinical application.

The protein ionization process can be significantly suppressed by impurity and salts. Separation of the sample components by open channel CIEF prior to the MALDI-MS analysis minimizes the potential of signal suppression due to the presence of other sample components in same spot. The effect of salts (cations and anions) in the sample can be minimized because ions will migrate out of the separation channel under the influence of the applied electric field. The focused laser into small spot provides high spatial resolution allowing analysis of sample only a few micro meter size. Therefore, the high resolution separation of proteins by capillary isoelectric focusing can be retained in the second dimension by laser desorption/ionization. Open channel CIEF-MALDI as described in this document is expected to have high sensitivity because the focused proteins are concentrated on a small spot in a narrow channel.

The invention is described further, for the purpose of illustration only, in the following examples.

### EXAMPLES

### Example 1

### Materials and Reagents

Poly(methylmethacrylate) (PMMA) is purchased from a local supplier (Swees Engineering Co. (PTE) Ltd.). Myoglobin, glycerol, pharmalyte, methylcellulose are ordered from Sigma Chemicals. All other chemicals are acquired from Aldrich Chemicals. All solutions are prepared using water purified by a Nanopure water system. Platinum wires are supplied by Fine Metal Crop.

### Example 2

### Fabrication of Open Microchannel

Pieces of PMMA plates, 90 mm by 30 mm and 3 mm thickness, are cut from a raw plastics plate. Platinum wires with diameters of 0.005 inches and 0.007 inches are used to imprint the channels in the plastic substrate. A platinum wire about 150 mm in length is stretched taut by clamping the ends to a wire tension bow. The PMMA and a glass plate sandwich the platinum wire and are clamped together between two aluminium blocks. Electrical current is passed through the platinum wire until it is red hot while pressure on the aluminium block is applied by tightening the clamp. When the assembly is cooled down completely, the clamp is released and the platinum wire is pulled away from the plastic to reveal the channel.

In one design, holes at the ends of the channel are drilled for the electrolyte reservoirs. In another design, a cover plate is used to cover up the open microchannel during the focusing to minimize is evaporation and carbon dioxide absorption to sample solution. The cover plate was fabricated from PMMA using standard machining methods.

### Example 3

### Open Channel Capillary Isoelectric Focusing

Myoglobin is used as model protein for the method development because it has a brownish colour and can be detected by human eyes. The sample is prepared in the concentration of 0.02 μg/μl of myoglobin, 1% of Pharmalyte 3-10. About 5 μl of sample is applied to the open microchannel by a micropipette. The sample spreads out evenly in the microchannel by capillary action.

100 mM potassium hydroxide in 1.5% methylcellulose is used as catholyte and 50 mM phosphoric acid in 1.5% methylcellulose is used as anolyte. The methylcellulose significantly increases the viscosity of the electrolytes. Two different setups are used for the isoelectric focusing as shown in FIGS. 1 to 4 and in FIGS. 5 to 8.

In the first design (see for example FIG. 4), the electrolytes are filled in two reservoirs at the ends of the open microchannel respectively. The sample in the microchannel and the electrolytes in the reservoirs are separated by an agarose gel set in the boundary of reservoir and microchannel. The high viscosity of the electrolytes and the agarose gel prevents mixing of the sample with the electrolytes during the focusing while still allowing ion passage through the agarose gel. Platinum wires are attached to the reservoirs for electrical contact.

In the second design (see for example FIG. 7), the microchannel is covered up by a cover plate, and the electrolyte reservoirs are made from modified micropipettes. Two holes are drilled in the cover plate to receive the micropipettes, and the micropipettes are attached to the cover plate as shown in FIGS. 6A and 6B.

The tip of the micropipette is about 10 μm in diameter and is pointed downward to the microchannel. The tips of the micropipettes are filled with a thin layer of agarose gel to prevent mixing of the electrolytes and the sample while allowing ions to migrate through the junction. The reservoirs modified from the micropipettes are filled with the high viscosity catholyte and anolyte. Electrical contact is through platinum wires immersed in the electrolyte solutions.

The electrical voltage is varied from 500 V initially to 5 kV in the final stage of focusing depending on the electrical current passing through the channel. The progress of the focusing is monitored by recording picture using a Nikon D-100 digital camera.

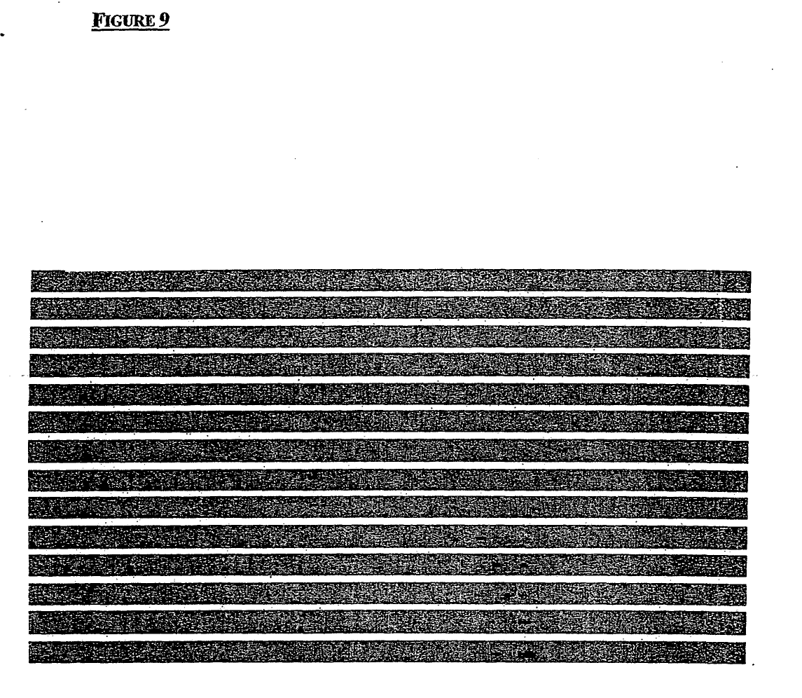

FIG. 9 shows the progress of IEF of myoglobin in a PMMA open channel with 0.007 inches width (175 micrometres). The pictures are recorded using a digital camera After proteins are focused into a narrow zone, as indicated by a drop in the focusing current to a constant value, the voltage applied across the capillary channel is gradually increased to tighten the focusing zones. In addition, Joule heating is increased to evaporate the solvent in the microchannel so that the focused dried protein does not move when the applied voltage is terminated.

It is more convenient to carry out the focusing in “open system”, where the cartridges are essentially open to the atmosphere. However, in some experiments, we found it advantageous to control the atmosphere surrounding the cartridge, in particular, the humidity and carbon dioxide concentration. Without a controlled environment, there is a possibility that the sample would dry out. Furthermore, there is a possibility that carbon dioxide in air would slowly dissolve into the sample solution, perturbing the pH gradient and possibly decreasing the resolution of the separation. If the sample was left in air for a long time, the amount of carbon dioxide dissolving into the sample might be high enough to completely destroy the pH gradient. Use of suitable buffers which minimise pH effects from external sources can also be employed in addition to use of a humidity and CO₂ controlled environment.

In these experiments, we placed the PMMA cartridge with the open capillary charnel in a controlled environment to produce a “closed system”. Such controlled environments allow the amount of humidity (relative humidity) and carbon dioxide to be specifically controlled. Although separation was satisfactory in the “open” configuration, we found better results using controlled humidity and carbon dioxide free atmosphere.

### Example 4

### Coupling MALDI-MS

MALDI-MS experiments are performed in Bruker Daltonics Autoflex MALDI time-of-flight mass spectrometer (TOF-MS) operating in the linear mode.

An adapter is fabricated to hold the plastic CIEF cartridge on the standard Bruker MALDI sample plate as shown in FIGS. 3, 4C, 5C, 7C and 10. Saturated sinapinic acid in acetonitrile with 1% acetic acid is loaded on top of the dried sample in the microchannel. The matrix is added slowly in several small amounts to the microchannel to prevent degradation and broadening of the focused zone.

The solvent is then allowed to evaporate by exposing to air at room temperature. As acetonitrile has a very low vapour pressure, exposure to air enables the solvent to evaporate.

After solvent evaporation, the cartridge is put into an adapter on the standard Bruker Daltonics MALDI plate (FIG. 10). The MALDI with delayed ion extraction is carried out with a conventional nitrogen laser operating at 337 nm wavelength. The MALDI laser is focused on the centre of the microchannel and the MALDI plate is moved slowly across the laser while maintaining the laser on the centre of the microchannel.

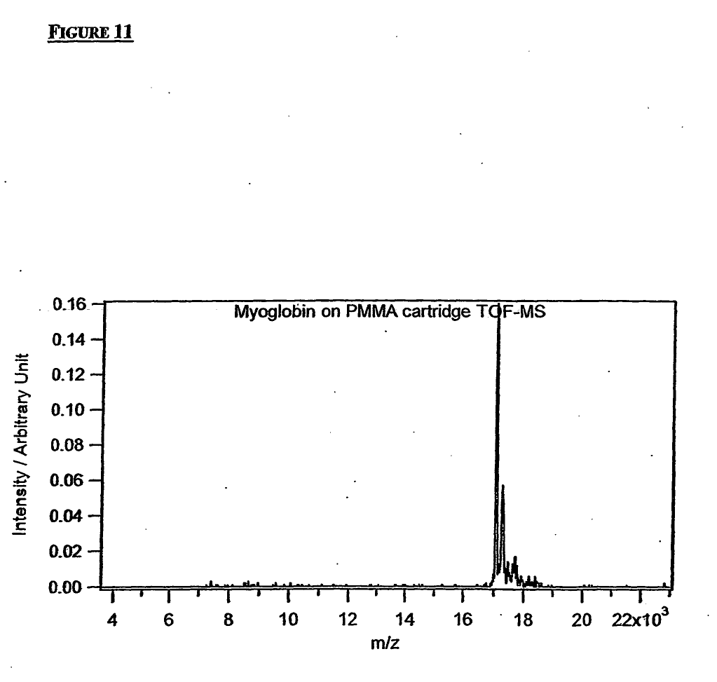

As shown in FIG. 11, the myoglobin signal from the focused zone in PMMA channel has comparable resolution and sensitivity to sample directly applied to standard stainless steel MALDI plate. The carrier ampholytes did not affect the ionization of myoglobin.

Alternatively, a small amount of glycerol (1-2%) may be mixed with the sample before loading into the microchannel. Glycerol can prevent proteins precipitating when protein concentrations increase around their pI points. After isoelectric focusing, the solvent may be evaporated by either freeze dry or by increasing the applied voltage for Joule heating. The low vapour pressure glycerol, carrier ampholyte and proteins will stay in the channel, the proteins can then be ionized by applying an IR laser for IR MALDI-MS because glycerol is a good IR MALDI matrix (Siegel, M. M., Tabei, K, Kunz, A., Hollander, I. J., Hamann, P. R, Bell, D. H., Berkenkamp, S., Hillenkamp, F., Anal Chem. 1997, 69, 2716-2726).

### Example 5

### Separation of Liver Proteins

Proteins are extracted from pig liver using the following protocol. Porcine liver is mixed with 2× volume of deionized water and homogenized using a blender. The cells are lysed using a sonicator. The mixture is centrifuged, and the supernatant is diluted 2 times with deionized water and used for open channel CIEF without further purification. Open channel CIEF is carried out essentially as described in Example 3, and MALDI separation may be carried out essentially as described in Example 4.

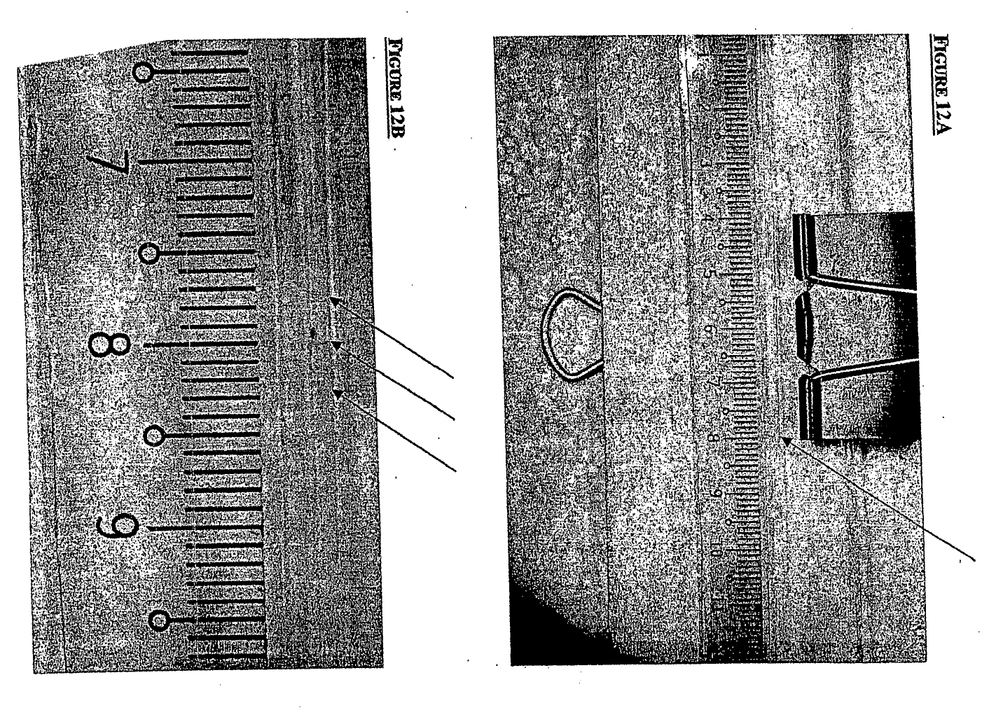

The results of the open channel CIEF of pig liver proteins are shown in FIGS. 12A and 12B. FIG. 12B shows a magnified portion of FIG. 12A. Three brown spots representing separated proteins are observed at around position 8 of the ruler, indicated by arrows. The ruler is position to provide an estimate of the pI in the particular corresponding region of the channel; accordingly, it will be seen that the method and module/apparatus described here is capable of resolving three visible proteins having similar or close pI values from a complex liver extract.

The three spots represent only three of the proteins present in the liver extract, which are visible to the eye. Needless to say, the liver extract comprises many other proteins, which have been separated by the isoelectric focussing module and method described here.

Other Aspects

FIG. 4A illustrates a top view of one embodiment of the invention. A plurality of open micro-capillary channels (2) are etched or built on a substrate (1). Two electrolyte reservoirs (3 and 4) are etched or built on the sample substrate. One reservoir is on one end of the micro-capillary channels, another is on the other end of the micro-capillary channels. The two ends of the open capillary channels are connected to two reservoirs respectively through narrow channels, semi-permeable membrane or gel in the boundary to prevent mixing of sample with anolyte or catholyte. The reservoirs are for anolyte and catholyte solutions. The substrate can be any non-conductive materials such as polymeric, ceramic, glass, or composite materials. FIG. 4B shows the cross-section of the multiple open micro-capillary channels (2). The cross-section of the channels is not restricted to a rectangular shape but it can be any shape. Each of the different protein samples will be loaded into one unique channel. When an electric potential is applied across the anolyte and catholyte, the proteins will move under the electric field to their pI points. The separated proteins can be directly ionized with a MALDI laser on top of the open channels without mobilizing the proteins. Instead of mobilizing the separated proteins, the whole CIEF cartridge will be put on a translational stage and the proteins will be brought to the MALDI laser spot by moving the translational stage. As a result, the high resolution achievable with CIEF is preserved in the detection process. Moreover, many open capillary channels can be built on a CIEF cartridge, the number of channels is not fixed rather it can be as many as the cartridge can hold. Therefore, many samples can be separated in parallel for high throughput application.

The CIEF separation can be done with or without carrier ampholyte. In one embodiment, pH gradient can be formed by immobilizing some acidic and basic compounds on the capillary wall. MALDI matrix, such as glycerol (0-50%), will be added to the protein samples before CIEF separation. The glycerol, in this example, will serve as infrared MALDI matrix for the protein ionization, it also prevents precipitation of protein in the focused zone and minimizes electroosmotic flow. After CIEF separation, the CIEF cartridge is quickly cooled down to freeze the sample to prevent movement of the separated zones. Then, the cartridge is put into a vacuum chamber to freeze dry the sample, i.e. to evaporate the ice. What remains in the MOC-CIEF cartridge is the low vapour pressure compounds: mainly separated proteins and MALDI matrix such as glycerol. The cartridge is then loaded into the translational stage in the MALDI ionization source. FIG. 4C shows the cross section of the multiple open channels (2) capillary isoelectric focusing cartridge (1) mounted on a XY-translational stage (5) in MALDI source. A MALDI laser (6) will be focused on one spot of the open capillary channels to ionize the proteins. The translational stage will be moved to consecutively bring the whole open channel to the focused laser spot. Therefore, 2-dimensional protein separation and analysis can be achieved. The protein molecular ions from the MALDI source can be fragmented by post source decay or collisionally activated dissociation for protein identification.

Each of the applications and patents mentioned in this document, and each document cited or referenced in each of the above applications and patents, including during the prosecution of each of the applications and patents (“application cited documents”) and any manufacturer's instructions or catalogues for any products cited or mentioned in each of the applications and patents and in any of the application cited documents, are hereby incorporated herein by reference. Furthermore, all documents cited in this text, and all documents cited or referenced in documents cited in this text, and any manufacturer's instructions or catalogues for any products cited or mentioned in this text are hereby incorporated herein by reference.

Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in bioanalytical chemistry, or molecular biology, or related fields are intended to be within the scope of the claims.

1. An isoelectric focussing (IEF) module comprising:
(a) a first planar member having a covered channel along which a sample may be loaded and at least one compound compount thereof focussed isoelectrically; and
(b) means for exposing the channel along at least a portion of its length and thereby exposing the sample or component(s) therewithin.

2. A module according to claim 1, in which the sample or component are accessible along the exposed channel at substantially the positions at which they are focussed.

3. A module according to claim 1, in which the channel comprises an open channel which is exposed along at least a portion of its length.

4. A module according to claim 1, in which the channel comprises a linear groove formed on a surface of the first planar member.

5. A module according to claim 1, in which the channel comprises a microchannel or capillary channel.

6. A module according to claim 5, in which the microchannel or capillary channel is microfabricated on the first planar member.

7. A module according to claim 1, in which the channel has a width of between 1 to 500 micrometres, more preferably between 50 to 350 micrometres, more preferably between 50 to 350 micrometres, most preferably about 150 micrometers or about 175 micrometres.

8. A module according to claim 1, in which the first planar member is formed from a material selected from the group consisting of: plastics, polymers, ceramic, glass or composite.

9. A module according to claim 1, in which at least one wall of the channel comprises poly(methylmethacrylate) (PMMA) or polycarbonate.

10. A module according to any of claim 1, in which the first planar member is coated or derivatised to reduce surface charge and thereby minimise electroosmotic flow (EOF).

11. A module according to claim 1 further comprising a reservoir for electrolyte, the reservoir being in electrical connection with the channel.

12. A module according to claim 11, in which the reservoir is formed on the first planar member adjacent to each end of the channel.

13. A module according to claim 1, further comprising a lid being a second planar member, which reduces evaporation of the sample in the channel.

14. A module according to claim 13, in which the lid comprises an elongate recess on its inner face, the recess being positioned such that when the lid is mated with the first planar member, no substantial leakage of sample contained in the channel occurs.

15. A module according to claim 14, in which the length and width of the recess are at least as great as a channel in the first planar member.

16. A module according to claim 11 and 13, in which the reservoir is disposed on the lid.

17. A module according to claim 11, further comprising means for electrical connection between the channel and the reservoir without resulting in substantial mixing of sample and electrolyte.

18. A module according to claim 17, in which said means comprises a semi-permeable membrane, agarose, or a gel plug.

19. A module according to claim 1, comprising which comprises a plurality of channels in substantially parallel orientation.

20. A module according to claims 1 and 19, in which a channel comprises a closed channel and the means for exposing the channel comprises lines of weakness enabling fracture along a longitudinal plane of the channel.

21. A module according to claim 1 further comprising a translational stage on which is mounted the first planar member.

22. An apparatus for separating one or more components in a sample, the apparatus comprising an isoelectric focussing module according to claim 1, together with a module capable of separating isoelectrically focussed components according to their respective masses.

23. An apparatus according to claim 22, in which the mass separation module comprises a module for mass spectrometry.

24. An apparatus according to claim 23 in which the mass separation module comprises a matrix assisted laser desorption/ionisation mass spectrometry (MALDI-MS) module.

25. A method of separating one or more components in a sample, the method comprising the steps of:
(a) providing an isoelectric focussing (IEF) module comprising a first planar member having a covered channel;
(b) loading the covered channel with a sample;
(c) isoelectrically focussing a component or components of the sample along the channel;
(d) exposing the channel along at least a portion of its length and thereby exposing the sample or component(s) therewithin;
(e) optionally coating the isoelectric focussing (IEF) module with an electrical conductive thin film or layer; and
(f) optionally analysing one or more separated components by mass spectrometry.

26. (canceled)

27. A method according to claim 25, further comprising the step of: (e) accessing one or more components in the open channel and analysing it.

28. A method according to claim 27, in which the or each component is analysed by mass spectrometry.

29. A method according to claim 25, in which the sample comprises a MALDI matrix.

30. A method according to claim 29, in which a MALDI matrix is added to the sample subsequent to isoelectric focussing.

31. A method according to claim 29 or 30, in which the MALDI matrix is selected from the group consisting of: Cyano-4-hydroxycinnamic acid (CHCA), 2,5-Dihydroxy benzoic acid (DHB), Alpha CCA, Sinapinic Acid (SA), 3-hydroxypicolinic acid (HPA), IAA (Na⁺), 2-(4-Hydroxyphenylazo)benzoic acid HABA (Na⁺), Dithranol (Na⁺), Retinoic Acid (Na⁺), Succinic acid, 2,6-Dihydroxyacetophenone, Ferulic Acid, Caffeic acid, Glycerol and 4-Nitroaniline.

32. A method of analysing a molecule, the method comprising:
(a) providing an elongate open channel;
(b) introducing a plurality of molecules into the elongate open channel;
(c) separating molecules along the elongate open channel according to their isoelectric points; and
(d) accessing a molecule in the elongate open channel and analysing it.

33. An apparatus for isoelectric focussing (IEF) of molecules, the apparatus comprising an elongate channel, in which the elongate channel is open along at least a portion of its length to enable separated molecules to be accessed.

34. (canceled)

35. A kit comprising a module or apparatus as claimed in claim 1, 22 and 33 and further comprising a sample comprising proteins to be analysed.

36. A method of detecting a protein in a sample, the method comprising the steps of:
(a) providing an elongate open channel;
(b) introducing the sample into the elongate open channel;
(c) separating the protein along the elongate open channel according to its isoelectric point;
(d) accessing the protein in the elongate open channel; and
(e) detecting the protein by mass spectrometry.

37. (canceled)

38. (canceled)

39. (canceled)

40. (canceled)

41. A method of diagnosis of a disease in an individual, the method comprising the steps of:
(a) providing a cell, tissue or organ sample from an individual, and producing a protein containing extract thereof;
(b) detecting a disease associated protein in the sample using a module according to claim 1, an apparatus according to claim 22, or a method according to claim 25.

42. A means for interfacing a capillary isoelectric focussing (CIEF) apparatus and a MALDI-MS apparatus comprising a covered channel along which isoelectric focussing is carried out, and means for exposing said channel along at least a portion of its length and thereby exposing the sample or component(s) therewithin.

43. An interface according to claim 42 which comprises an open channel.

44. An apparatus according to claim 24 wherein the mass separation module comprises a matrix assisted laser desorption/ionization-time of flight (MALDI-TOF).

45. The method according to claim 25 wherein the components are analyzed by MALDI-MS.

46. The method according to claim 25 wherein the components are analyzed by MALDI-TOF.

47. The method according to claim 27 wherein a component is analyzed by MALDI-MS.

48. The method according to claim 27 wherein a component is analyzed by MALDI-TOF.

49. A means for interfacing a capillary isoelectric focussing (CIEF) apparatus and a MALDI-TOF apparatus comprising a covered channel along which isoelectric focussing is carried out, and means for exposing said channel along at least a portion of its length and thereby exposing the sample or component(s) therewithin.

50. An interface according to claim 43 which comprises an open channel.
